(19) United States
(12) Patent Application Publication
(10) Pub. No.: US 2025/0091376 A1
(43) Pub. Date: Mar. 20, 2025

(54) MEDIA CONSTRUCTION TO FACILITATE USE OF ACTIVATABLE PLATFORM

(71) Applicant: Temptime Corporation, Morris Plains, NJ (US)

(72) Inventors: Eric W. LIBERATO, Pequannock, NJ (US); Anthony J. CECCHIN, Kildeer, IL (US); Mohannad ABDO, Clifton, NJ (US); Gene A. HOFER, Lake Zurich, IL (US)

(73) Assignee: Temptime Corporation, Morris Plains, NJ (US)

(21) Appl. No.: 18/369,536

(22) Filed: Sep. 18, 2023

(51) Int. Cl. B41M 3/00; B41M 5/50; G01J 1/48; G01J 1/50; G01K 11/12; G01N 21/77; G01N 21/78; G01N 27/12; G01N 27/22

(52) U.S. Cl. CPC B41M 3/006; B41M 5/502; G01J 1/48; G01J 1/50; G01K 11/12; G01N 21/77; G01N 21/78; G01N 27/12; G01N 27/227

(57) ABSTRACT

Disclosed is a media element including an environmental indicator material configured, in response to exposure to a predetermined environmental condition, to change from an initial state to a second state producing an observable effect. The media element further includes a plurality of microcapsules, each microcapsule encapsulating the environmental indicator material in a non-activated configuration and releasing the environmental indicator material when ruptured. The microcapsules prevent an occurrence of the observable effect while in the non-activated configuration and allow the occurrence of the observable effect when the environmental indicator material is exposed to the predetermined environmental condition after at least a portion of the plurality of microcapsules are ruptured. The media element further includes a bursting additive proximate the plurality of microcapsules. The bursting additive selectively interacts with the plurality of microcapsule to rupture the plurality of microcapsules when a force is applied to the plurality of microcapsules and bursting additive.

### BACKGROUND

The present disclosure generally relates to media, such as labels that can be printed or otherwise processed with media processing devices, such as printers. Once the media processing devices print on the labels, the labels can be placed on objects, such as packages, products for sale at retail, stock shelf labels, etc. A supply of labels may be provided in various forms, such as a roll or stack, and the labels may come in different sizes (e.g., different shapes, lengths and/or widths) which may be printed.

### BRIEF DESCRIPTION OF THE SEVERAL VIEWS OF THE DRAWINGS

The novel features of the various aspects are set forth with particularity in the appended claims. Throughout the FIGS. like reference characters designate like or corresponding parts throughout the several views of the drawings. The described aspects, however, both as to organization and methods of operation, may be best understood by reference to the following description, taken in conjunction with the accompanying drawings in which:

FIG. 1 illustrates a media processing device, according to at least one aspect of the present disclosure.

FIG. 2 illustrates the media processing device of FIG. 1 with an access door in an open position, according to at least one aspect of the present disclosure.

FIG. 3 illustrates a side view of the media processing device of FIG. 1 with a roll of media installed, according to at least one aspect of the present disclosure.

FIG. 4 illustrates a detailed view of a printing mechanism of the media processing device of FIG. 1 wherein the printing mechanism is disposed in a loading position, according to at least one aspect of the present disclosure.

FIG. 5 illustrates a detailed view of the printing mechanism of FIG. 4, wherein the printing mechanism is disposed in a printing position, according to at least one aspect of the present disclosure.

FIG. 6 illustrates a detailed view of the printing mechanism of FIG. 4, wherein the printing mechanism is disposed in the loading position and a ribbon has been installed, according to at least one aspect of the present disclosure.

FIG. 7 illustrates a detailed view of the printing mechanism of FIG. 6, wherein the printing mechanism is disposed in the printing position, according to at least one aspect of the present disclosure.

FIG. 8 illustrates a diagram of a cross-section of an example media element including an environmental sensor, according to at least one aspect of the present disclosure.

FIG. 9 illustrates an example view of a plurality of microcapsules of an environmental sensor on a media element, according to at least one aspect of the present disclosure.

FIG. 10 illustrates a microcapsule rupturing after an activation process, according to at least one aspect of the present disclosure.

FIG. 11 illustrates a diagram showing a media element exposed to the predetermined environmental condition before and after activation, according to at least one aspect of the present disclosure.

FIG. 12 illustrates a diagram of an example media element passing between two activation mechanism components, according to at least one aspect of the present disclosure.

FIGS. 13A and 13B illustrate a diagram of a media element with a plurality of microcapsules and a bursting additive in the same layer of a printable substrate, according to at least one aspect of the present disclosure.

FIGS. 14A to 19B illustrate different diagrams of a media element with a plurality of microcapsules in one layer of the printable substrate and a bursting additive in a different layer of the printable substrate, according to at least one aspect of the present disclosure.

FIGS. 20A and 20B illustrate a diagram of a media element with a plurality of microcapsules in one layer of the printable substrate and a bursting additive in a different layer of the printable substrate without a release liner, according to at least one aspect of the present disclosure.

FIGS. 21A and 21B illustrate a diagram of a media element with a plurality of microcapsules in one layer of a printable substrate and a bursting additive in a layer of a release liner, according to at least one aspect of the present disclosure.

FIGS. 22A and 22B illustrate a diagram of a media element with a plurality of microcapsules in two different area of a layer of a printable substrate and bursting additives in a different layer of the printable substrate, according to at least one aspect of the present disclosure.

FIGS. 23A and 23B illustrate a diagram of a media element with a first plurality of microcapsules and a second plurality of microcapsules in a layer of a printable substrate and bursting additives in a different layer of the printable substrate, according to at least one aspect of the present disclosure.

FIGS. 24A and 24B illustrate a diagram of a media element with a first plurality of microcapsules in a first layer of a printable substrate, a second plurality of microcapsules in a second layer of the printable substrate, a first bursting additive in a third layer of the printable substrate, and a fourth bursting additive in a fourth layer of the printable substrate, according to at least one aspect of the present disclosure.

FIGS. 25A and 25B illustrate a diagram of a media element with a first plurality of microcapsules in a first layer of a printable substrate, a second plurality of microcapsules in a second layer of the printable substrate, and bursting additives in a third layer of the printable substrate, according to at least one aspect of the present disclosure.

FIGS. 26A and 26B illustrate a diagram of a media element with a printable substrate that includes a heat activated thermal coating in one layer of the printable substrate and a plurality of microcapsules and a bursting additive in another layer of the printable substrate, according to at least one aspect of the present disclosure.

FIGS. 27A to 35B illustrate diagrams of media elements with a printable substrate that includes a heat activated thermal coating, a plurality of microcapsules, and a bursting additive, according to at least one aspect of the present disclosure.

FIG. 36 illustrates a diagram of an example media element passing between two activation mechanism components, where the media element includes a bursting additive, according to at least one aspect of the present disclosure.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The following detailed description of example implementations refers to the accompanying drawings. The same reference numbers in different drawings may identify the same or similar elements.

Environmental sensors using chemical based indicators (e.g., formed with environmental indicator materials) can provide an observable response. Such indicators may produce an observable response in response to a predetermined environmental condition, for example a change in color state, e.g., hue, transparency, darkness, etc., a change in an electrical property, or a change a state of matter (e.g., viscosity or fluidity), in response to exposure to the predetermined environmental condition. As one example, an environmental sensor that uses chemical based indicators may be configured to produce an observable effect when a temperature of the environment is above a predetermined temperature threshold.

Such environmental sensors may be partly limited, or produced with higher costs, due to, for example, manufacturing and/or handling requirements. For example, in a practical application, for an environmental sensor that use a chemical based indicator to produce an observable effect in response to high temperature excursions, e.g., an ambient temperature that is too warm, the environmental indicator materials utilized in the chemical based indicator are often required to be manufactured and/or handled in environments that do not satisfy the predetermined environmental condition (e.g., environments that are below a response temperature) prior to their use with a host product. Similarly an environmental sensor that uses a chemical based indicator configured as a humidity detector needs to be kept dry, and an environmental sensor that uses a chemical based indicator configured as a UV or light exposure indicator needs to be kept out of the sun, prior to deployment with a host product.

One solution to simplifying the use of such environmental sensors that use chemical based indicators, and particularly the management of the supply chain of such environmental sensors prior to pairing, deploying, or otherwise associating the environmental sensors with products, is to introduce mechanisms to selectively activate the environmental indicator materials of the environmental sensors at the end point of application. Some prior activatable indicators rely on keeping materials separate mechanically and then joining them together, e.g., by removing a barrier sheet or bringing two halves a clamshell structure into close contact. Prior to activation, the indicator does not react with relevant environmental stimulus. Another approach to this is to encapsulate the environmental indicator materials and activate them by rupturing the encapsulation to release the indicator materials as described herein and in concurrently filed related applications: U.S. patent application, titled “PRINTER ACTIVATABLE ENVIRONMENTAL SENSING THROUGH CHEMICAL ENCAPSULATION”, Attorney Docket No. 0820887.00357; U.S. patent application, titled “MEDIA PROCESSING DEVICE AND COMPONENTS FOR ACTIVATABLE MEDIA PLATFORMS”, Attorney Docket No. 0820887.00358; U.S. patent application, titled “USE OF ENCAPSULATED POLAR PROTIC CHEMISTRIES FOR RFID TEMPERATURE MONITORING”, Attorney Docket No. 0820887.00355; and U.S. patent application, titled “RIBBON FOR USE IN PRODUCING PRINTER ACTIVATABLE INDICATORS”, Attorney Docket No. 0820887.00356.

The encapsulated environmental indicator materials can be placed on media to form an environmental sensor on the media. The environmental sensor can then be later activated with physical forces such as pressure, sheer, cutting or friction sufficient to rupture the encapsulation. The forces can be applied with a device, e.g. a media processing device, or by a user pinching environmental sensor by hand. In some aspects, heat is also applied to the environmental sensor for activation. In at least one aspect, the media can include a bursting additive to increase the ease of rupturing the indicator materials' encapsulation and activate the environmental sensor.

Introducing supplies with textured surfaces or materials that increase the frictional force or hardness can help promote rupturing of the encapsulated materials and increase the environmental sensing capabilities by rupturing more of microcapsules with the textured surface than without the textured surface. As an example, an abrasive material can be introduced directly into a media element containing the environmental sensor. The abrasive material can be added to a media construction, or a media substrate surface can be modified, in a manner that will cause an increase in the strain the microcapsules will experience. Some example materials or surfaces that can be added include sandpaper, microneedles, glass, metal, silica, plastic, and stone paper, which can enhance the sensitivity of activatable mechanism.

The solution of having an activatable environmental sensor layer may provide various benefits. The environmental sensor has a non-activated configuration where the media with the environmental sensor can be stored in the non-activated configuration without worrying about ruining the environmental sensor. For example, if the environmental sensor was designed to respond to a temperature above a response temperature, the media with the environmental sensor can be stored in the non-activated configuration at a temperature above the response temperature without ruining the environmental sensor. This avoids the need to maintain a strict cold chain for the environmental sensors before they are paired with products. Then later, e.g., when media containing the environmental sensor is being deployed or associated with a particular product (e.g., by applying the media to a package or including the media in the package) the environmental sensor on the media can be placed in an activated configuration, where the environmental sensor would from that point on provide a detectable response when a predetermined environmental condition is satisfied (e.g., provide a detectable response when the temperature increasing above the response temperature). Additionally, the ability to maintain the environmental sensor in the non-activated configuration and activate the environmental sensor on demand facilitates the end-user activating the environmental sensor when desired. This process should allow the end-user to easily store media with environmental sensors that use chemical based indicators in the non-activated configuration and then activate the labels when the end-user needs to monitor an environmental condition relative to a response condition or threshold (e.g. a temperature threshold, a humidity threshold, etc.).

In one general aspect, the present disclosure provides a media element for use with a media processing device. The media element includes an environmental indicator material configured, in response to exposure to a predetermined environmental condition, to change from an initial state to a second state producing an observable effect. The media element further includes a plurality of microcapsules, each microcapsule encapsulating the environmental indicator material in a non-activated configuration and releasing the environmental indicator material when ruptured. The plurality of microcapsules prevent an occurrence of the observable effect while in the non-activated configuration and allow the occurrence of the observable effect when the environmental indicator material is exposed to the predetermined environmental condition after at least a portion of the plurality of microcapsules are ruptured. The media element further includes a bursting additive proximate the plurality of microcapsules. The bursting additive selectively interacts with the plurality of microcapsule to rupture the plurality of microcapsules when a force is applied to the plurality of microcapsules and bursting additive.

In at least one aspect, at least a portion of the plurality of microcapsules are ruptured based on a force greater than a predetermined threshold, the force being at least one of a pressure force, a shear force, a frictional force, or a cutting force applied to the media element. In at least one aspect, the at least the portion of the plurality of microcapsules are ruptured based on the pressure force, and wherein the predetermined threshold is between 1.5 and 8 pounds per square inch. In at least one aspect, the pressure force, the shear force, the frictional force, or the cutting force equal to or greater than the predetermined threshold is applied by the media processing device to the media element while the media element is passed through the media processing device. In at least one alternative aspect, the pressure force, the shear force, the frictional force, or the cutting force equal to or greater than the predetermined threshold is applied by a user. In at least one aspect, at least the portion of the plurality of microcapsules are ruptured based on the pressure force, and wherein the predetermined threshold is 20 pounds per square inch.

In at least one aspect, at least a portion of the plurality of microcapsules are ruptured based on both a force greater than a predetermined threshold and a temperature of the at least the portion of the plurality of microcapsules being equal to or greater than a predetermined temperature threshold. In this aspect, the force includes at least one of a pressure force, a shear force, a frictional force, or a cutting force applied to the media element. In at least one aspect, the predetermined temperature threshold is between 90° C. and 110° C. In at least one aspect, the predetermined temperature threshold is between 90° C. and 110° C. and at least the portion of the plurality of microcapsules are ruptured based on the pressure force, where the predetermined threshold is between 4 and 15 pounds per inch.

In at least one aspect, the bursting additive increases an effective force applied to the microcapsules when the force is applied to the media element.

In at least one aspect, each microcapsule of the plurality of microcapsules has at least a first wall and a second wall encapsulating the environmental indicator material, wherein the first wall is configured to rupture based, in part, on a temperature being equal to or greater than a predetermined temperature threshold, and wherein the second wall is configured to rupture based on a pressure force, a shear force, a frictional force, or a cutting force equal to or greater than a predetermined threshold.

In at least one aspect, the media element further includes a printable substrate including the plurality of microcapsules and the bursting additive. In at least one aspect, the plurality of microcapsules and the bursting additive are positioned in the same layer of the printable substrate. In at least one alternative aspect, the plurality of microcapsules are positioned in a first layer of the printable substrate and the bursting additive is positioned in a second layer of the printable substrate, where the plurality of microcapsules are aligned with the bursting additive.

In at least one aspect, the media element further includes a printable substrate comprising the plurality of microcapsules and a release liner positioned against the printable substrate, the release liner comprising the bursting additive. In this aspect, the plurality of microcapsules are aligned with the bursting additive.

In at least one aspect, the bursting additive includes a plurality of microneedles. In at least one alternative aspect, the bursting additive includes an abrasive material. In at least one aspect, the abrasive material includes particles. In at least one aspect, the particles comprise a diameter length between 25 nanometers to 500 micrometers. In at least one aspect, the particles are harder than the microcapsules. In at least one aspect, the bursting additive increases a hardness at an area of the bursting additive on the media element and the area has a hardness greater than or equal to a 2 on the Mohs hardness scale. In at least one aspect, the bursting additive reduces an amount of force required to be applied to the media element to rupture the plurality of microcapsules. In at least one aspect, at least a portion of the plurality of microcapsules are ruptured based on a pressure force being applied to the media element, and the bursting additive reduces the amount of pressure force required to be applied to the media element in order to burst the microcapsules by anywhere between 5 to 90 percent.

In at least one aspect, the bursting additive increases an effective pressure force applied to the microcapsules by up to 15 pounds per square inch.

In at least one aspect, the observable effect includes at least one effect selected from the group consisting of a color state change, a change in transparency, a change in hue, a change in an electrical property, a change in conductivity, a change in capacitance, a movement of the environmental indicator material along a substrate, and combinations thereof. In at least one aspect, the plurality of microcapsules prevent the observable effect by containing the environmental indicator material when it changes state. In at least one aspect, the plurality of microcapsules prevent the observable effect by protecting the environmental indicator material from exposure to the predetermined environmental condition.

In at least one aspect, the predetermined environmental condition includes at least one condition selected from the group consisting of: temperature excursion above a predetermined temperature threshold for at least a predetermined amount of time, temperature excursion below a predetermined temperature for at least a predetermined amount of time, cumulative exposure to temperature over a time period above a predetermined threshold for at least a predetermined amount of time, exposure to a particular chemical, oxygen exposure, ammonia exposure, exposure to a particular chemical above a threshold concentration, exposure to a particular chemical above the threshold concentration for at least a predetermined amount of time, exposure to at least a predetermined amount of radiation of a particular type, ultraviolet light exposure, humidity exposure, exposure to a humidity level above a predetermined threshold, and exposure to a humidity level above a predetermined threshold for at least a predetermined amount of time.

In at least one aspect, the environmental indicator material includes a polymer having side-chain crystallinity. In at least one aspect, the environmental indicator material includes an alkane wax.

In at least one aspect, the microcapsules include a gel. In at least one aspect, the microcapsules include a protein. In at least one aspect, the microcapsules include polyurea formaldehyde. In at least one aspect, the microcapsules include polymelamine formaldehyde. In at least one aspect, the microcapsules comprise a wax material. In at least one aspect, the microcapsules comprise emulsions. In at least one aspect, the microcapsules comprise a diameter length between 20 to 250 μm.

In at least one aspect, the media element includes a heat activated thermal coating.

In another general aspect, a method of activating an activatable media element. The method includes feeding the activatable media element into an upstream end of a print head assembly of a media processing device. The activatable media element includes an environmental indicator material configured, in response to exposure to a predetermined environmental condition, to change from an initial state to a second state producing an observable effect. The activatable media element further includes a plurality of microcapsules, each microcapsule encapsulating the environmental indicator material in an inactive configuration and releasing the environmental indicator material when ruptured. The plurality of microcapsules prevent an occurrence of the observable effect while in the inactive configuration and allow the occurrence of the observable effect when the environmental indicator material is exposed to the predetermined environmental condition after at least a portion of the plurality of microcapsules are ruptured. The activatable media element further includes a bursting additive proximate the plurality of microcapsules. The method further includes rupturing at least a portion of the plurality of microcapsules by applying at least one of a pressure force, a shear force, a frictional force, or a cutting force equal to or greater than a predetermined threshold to the media element. The bursting additive selectively interacts with the plurality of microcapsule to rupture the plurality of microcapsules when the force is applied to the plurality of microcapsules and bursting additive. The method further includes ejecting the media element out of a downstream end of the print head assembly and out of the media processing device.

In at least one aspect, the method further includes printing the activatable media element with the print head. In at least one aspect, at least the portion of the plurality of microcapsules are ruptured by the print head and roller while the activatable media element is printed, and the print head and the roller apply the pressure force greater than the predetermined threshold to the activatable media element. In at least one aspect, the predetermined threshold is between 1.5 and 8 pounds per square inch.

In at least one aspect, rupturing at least the portion of the plurality of microcapsules includes applying, by a user, the pressure force greater than the predetermined threshold to the activatable media element outside of the media processing device. In at least one aspect, the predetermined threshold is at least 20 pounds per square inch.

In at least one aspect, the activatable media element further comprises a printable substrate comprising the plurality of microcapsules and a release liner positioned against the printable substrate, the release liner comprising the bursting additive. In this aspect, the plurality of microcapsules are aligned with the bursting additive. In at least one aspect, the method further comprises removing the release liner from the printable substrate to apply the printable substrate to an object.

In at least one aspect, the bursting additive includes an abrasive material. In at least one aspect, the bursting additive includes a plurality of microneedles. In at least one aspect, the bursting additive includes particles. In at least one aspect, the particles include a diameter length between 25 nanometers to 500 micrometers. In at least one aspect, the particles are harder than the microcapsules. In at least one aspect, the bursting additive increases a hardness at an area of the bursting additive on the media element, and the area has a hardness greater than or equal to a 2 on the Mohs hardness scale.

In at least one aspect, the observable effect includes at least one effect selected from the group consisting of a color state change, a change in transparency, a change in hue, a change in an electrical property, a change in conductivity, a change in capacitance, a movement of the environmental indicator material along a substrate, and combinations thereof.

In at least one aspect, the predetermined environmental condition includes at least one condition selected from the group consisting of temperature excursion above a predetermined temperature threshold for at least a predetermined amount of time, temperature excursion below a predetermined temperature for at least a predetermined amount of time, cumulative exposure to temperature over a time period above a predetermined threshold for at least a predetermined amount of time, exposure to a particular chemical, oxygen exposure, ammonia exposure, exposure to a particular chemical above a threshold concentration, exposure to a particular chemical above the threshold concentration for at least a predetermined amount of time, exposure to at least a predetermined amount of radiation of a particular type, ultraviolet light exposure, humidity exposure, exposure to a humidity level above a predetermined threshold, and exposure to a humidity level above a predetermined threshold for at least a predetermined amount of time.

In yet another general aspect, the present disclosure provides a media processing device. The media processing device includes a media supply including a media element. The media element includes a printable substrate including an environmental indicator material configured, in response to exposure to a predetermined environmental condition, to change from an initial state to a second state producing an observable effect. The printable substrate further includes a plurality of microcapsules, each microcapsule encapsulating the environmental indicator material in an inactive configuration and releasing the environmental indicator material when ruptured. The plurality of microcapsules prevent an occurrence of the observable effect while in the inactive configuration and allow the occurrence of the observable effect when the environmental indicator material is exposed to the predetermined environmental condition after at least a portion of the plurality of microcapsules are ruptured. The media element further includes a bursting additive positioned proximate the plurality of microcapsules. The bursting additive selectively interacts with the plurality of microcapsule to rupture the plurality of microcapsules when a force is applied to the plurality of microcapsules and bursting additive. The media processing device further includes a print head positioned upstream of the media supply and a roller positioned proximate the print head. The media element is passed between the print head and the roller, and a portion of the plurality of microcapsules are ruptured while the media element is passed between the print head and roller.

In at least one aspect, the print head and the roller apply pressure force to the media element while the media element is passed between the print head and roller. In this aspect, the portion of the plurality of microcapsules are ruptured based on a force greater than a predetermined threshold, the force being at least one of a pressure force, a shear force, a frictional force, or a cutting force applied to the plurality of microcapsules by the bursting additive based on the pressure force applied by the print head and roller.

In at least one aspect, the pressure force applied by the print head and the roller to the media element is between 1.5 and 8 pounds per inch.

In at least one aspect, the bursting additive reduces an amount of force required to be applied to the media element to rupture the plurality of microcapsules.

In at least one aspect, the print head and the roller apply pressure force to the media element, the print head applies heat to the media element, and the portion of the plurality of microcapsules are ruptured based on both a force greater than a predetermined threshold and a temperature of the portion of the plurality of microcapsules being equal to or greater than a predetermined temperature threshold. In this aspect, the force includes at least one of a pressure force, a shear force, a frictional force, or a cutting force applied to the plurality of microcapsules by the bursting additive based on the pressure force applied by the print head and roller. In at least one aspect, the predetermined temperature threshold is between 90° C. and 110° C. In at least one aspect, the predetermined temperature threshold is between 90° C. and 110° C., and the predetermined threshold is between 4 and 15 pounds per square inch.

In at least one aspect, each microcapsule of the plurality of microcapsules has at least a first wall and a second wall encapsulating the environmental indicator material. The first wall is configured to rupture based, in part, on a temperature being equal to or greater than a predetermined temperature threshold and the second wall is configured to rupture based on a pressure force, a shear force, a frictional force, or a cutting force equal to or greater than a predetermined threshold.

In at least one aspect, the printable substrate further comprises the bursting additive. In at least one aspect, the plurality of microcapsules and the bursting additive are positioned in the same layer of the printable substrate. In at least one alternative aspect, the plurality of microcapsules are positioned in a first layer of the printable substrate and the bursting additive is positioned in a second layer of the printable substrate, wherein the plurality of microcapsules are aligned with the bursting additive.

In at least one aspect, the media processing device further includes a release liner positioned against the printable substrate, the release liner including the bursting additive, and wherein the plurality of microcapsules are aligned with the bursting additive.

In at least one aspect, the bursting additive includes an abrasive material. In at least one aspect, the bursting additive includes a plurality of microneedles. In at least one aspect, the bursting additive includes particles. In at least one aspect, the particles include a diameter length between 25 nanometers to 500 micrometers. In at least one aspect, the particles are harder than the microcapsules. In at least one aspect, the bursting additive increases a hardness at an area of the bursting additive on the media element, and wherein the area has a hardness greater than or equal to a 2 on the Mohs hardness scale.

In at least one aspect, the portion of the plurality of microcapsules are ruptured based on a pressure force being applied to the media element, and wherein the bursting additive reduces an amount of pressure force required to be applied to the media element in order to burst the microcapsules by anywhere between 5 to 90 percent.

In at least one aspect, the observable effect includes at least one effect selected from the group consisting of a color state change, a change in transparency, a change in hue, a change in an electrical property, a change in conductivity, a change in capacitance, a movement of the environmental indicator material along a substrate, and combinations thereof.

In at least one aspect, the predetermined environmental condition includes at least one condition selected from the group consisting of temperature excursion above a predetermined temperature threshold for at least a predetermined amount of time, temperature excursion below a predetermined temperature for at least a predetermined amount of time, cumulative exposure to temperature over a time period above a predetermined threshold for at least a predetermined amount of time, exposure to a particular chemical, oxygen exposure, ammonia exposure, exposure to a particular chemical above a threshold concentration, exposure to a particular chemical above the threshold concentration for at least a predetermined amount of time, exposure to at least a predetermined amount of radiation of a particular type, ultraviolet light exposure, humidity exposure, exposure to a humidity level above a predetermined threshold, and exposure to a humidity level above a predetermined threshold for at least a predetermined amount of time.

In at least one aspect, the microcapsules include a diameter length between 20 to 250 μm.

In at least one aspect, the printable substrate further includes a heat activated thermal coating.

In yet another general aspect, the present disclosure provides a method of forming an activatable media element. The method includes adding a plurality of microcapsules to a layer of a printable media substrate of the activatable media element, each microcapsule encapsulating an environmental indicator material. The environmental indicator material is configured, in response to exposure to a predetermined environmental condition, to change from an initial state to a second state producing an observable effect. In this aspect, the plurality of microcapsules are in a non-activated configuration and releasing the environmental indicator material when ruptured placing the plurality of microcapsules in an activated configuration. The plurality of microcapsules prevent an occurrence of the observable effect while in the non-activated configuration and allow the occurrence of the observable effect when the environmental indicator material is exposed to the predetermined environmental condition after at least a portion of the plurality of microcapsules are ruptured. The method further includes adding a bursting additive proximate the plurality of microcapsules, where the bursting additive selectively interacts with the plurality of microcapsules to rupture the plurality of microcapsule when a force is applied to the activatable media element.

In at least one aspect, the method further includes attaching a release liner to the media substrate of the media substrate of the activatable. In at least one aspect, the bursting additive is positioned in the release liner.

In at least one aspect, the plurality of microcapsules and the bursting additive are added to the layer of the printable substrate. In at least one aspect, the layer of a printable media substrate is a first layer of the printable media substrate and the bursting additive is positioned in a second layer of the printable substrate. In this aspect, the plurality of microcapsules are aligned with the bursting additive.

In at least one aspect, the bursting additive includes an abrasive material. In at least one aspect, the bursting additive includes a plurality of microneedles. In at least one aspect, the bursting additive includes particles ranging from 25 nanometers-500 micrometers. In at least one aspect, the particles are harder than the microcapsules.

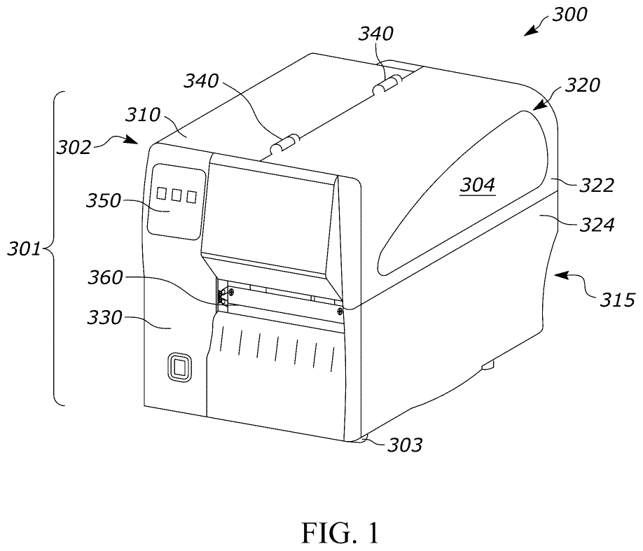

FIGS. 1-7 illustrate a media processing device 300 that can be used to process media elements that include environmental sensors. FIG. 1 illustrates a media processing device 300 according to at least one aspect of the present disclosure. While the illustrated embodiments and description provided herein are directed primarily to a printing device, other media processing devices such as media encoders, magnetic stripe readers, RFID readers, label re-winders, card laminators, label applicators, or other devices may be part of the media processing device. For example, printing, encoding, and/or laminating functionality may be incorporated into a single media processing device.

The media processing device 300 of FIG. 1 includes a housing 301 and a base 303. The housing 301 may include a front panel 330, a rear panel 315, a side panel 302, and a support surface 310. The housing 301 may include a user interface 350 and a media exit 360. The media exit 360 may be arranged in the front panel 330 of the media processing device 300 and may be configured to expel media after it has been processed. The housing 301 may further include an access door assembly 320 including a major door 322 and a minor door 324. The major door 322 may be hingedly attached to the support surface 310 with hinges 340 and the minor door 324 may be hingedly attached to the major door 322. The access door assembly 320 of FIG. 1 is illustrated in the closed, operational position in which access to the internal components of the media processing device is precluded. In addition to keeping dirt, dust, and foreign objects from entering an internal cavity of the media processing device and potentially contaminating the consumables or the electronics of the processing device, the closed door may also reduce noise and prevent users from inadvertently touching sensitive components.

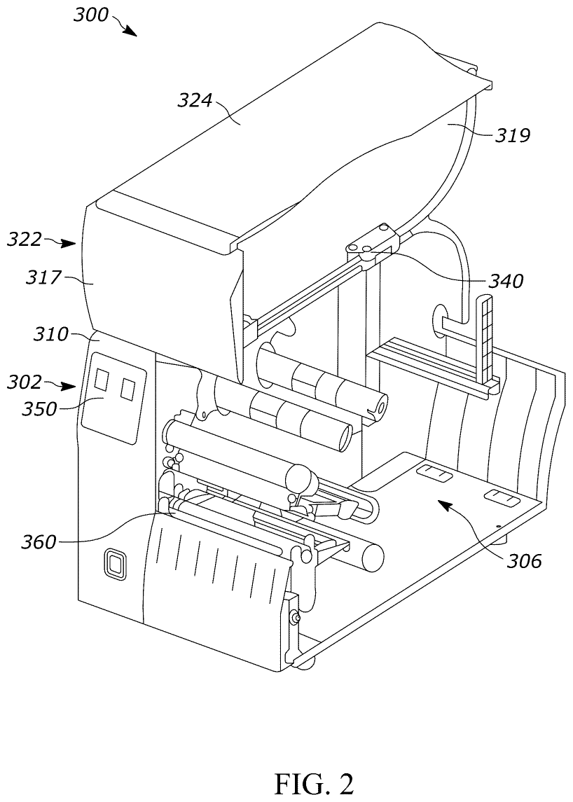

Referring to FIG. 2, positioning the hinges 340 proximate a centerline of the housing 301 allows the access door assembly 320 to pivot about hinges 340 and achieve the major support position when the major door 322 comes to rest on the support surface 310. Locating the hinges 340 proximate the centerline of the housing 301 further enables the side panel 302 of the media processing device to be situated against a surface, such as a wall or a cabinet, while still permitting the access door assembly 320 to achieve the major support position. The major door 322 may include at least a portion of the front panel 317 and/or a portion of the rear panel 319 to provide greater access to the internal cavity 306 when the major door is disposed in the major support position as will be described further below. In an alternative aspect, however, the major door 322 may include only a portion of the front panel.

The minor door 324 may be hingedly attached to the major door 322 and pivotable between an operational position (as shown in FIG. 1) and a minor support position (as shown in FIG. 2). In the operational position, the minor door 324 may be substantially co-planar with the access door assembly side 304 of the housing. In this operational position, the media processing device is ready for use and the internal cavity 306 is not accessible due to the position of the access door assembly 320. When the major door 322 is in the major support position, access to all of the necessary components to load and unload consumables (e.g., print media and printer ribbon) within internal cavity 306 is provided.

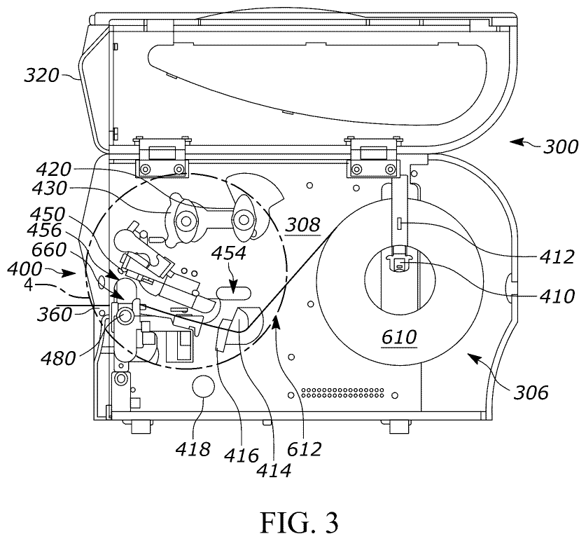

Before a printing operation may begin, the print media must be loaded into the media processing device. FIG. 3 illustrates the media processing device 300 of FIG. 1 with a media supply roll 610 loaded on a media spindle or hanger 410. In at least one aspect, the media processing device 300 includes a media spindle alignment feature 412, a media guide 414, and a media sensor 416. The alignment feature 412 that may fold or rotate to a loading position, whereby a media supply roll 610 may be loaded onto the media spindle 410, and subsequently, the alignment feature 412 may fold or rotate back into engagement with the media supply roll 610 to maintain the media supply roll 610 in the proper position on the media spindle 410. The media supply roll 610 is positioned upstream of the print head assembly 450. For example, the media web 612 may extend from the media supply roll 610, through one or more guiding features, to the printing mechanism 400, i.e. printing assembly, and/or other processing components. In at least one aspect, the media web 612 extends from the media supply roll 610, around the media guide 414 and past the media sensor 416 to arrive at the print head assembly 450. A media element of the media web 612 is loaded into an upstream end 454 of the print head assembly 450.

In at least one aspect, the media processing device 300 can include a media input instead of a media supply roll 610. For example, a media element can enter into the media processing device through the media input and be loaded the upstream end 454 of the print head assembly 450. As another example, a media supply can be located outside of the media processing device and a media web of the media supply can extend through the media input and be loaded the upstream end of the print head assembly 450. In an alternative aspect, the media can be supplied from a media stack instead of a media roll (e.g. a stack of plastic cards or a fanfold web of tag stock).

The media sensor 416 may provide a signal to the printer electronics when the media web is present which may allow the printer to determine when printing may occur. The media sensor may be configured to read or otherwise sense the transition or delineation between individual media elements on the media web 612 to enable alignment of the image printed at the print line of the print head 460 relative to the edges of the media element. The media web 612 may extend along the print head assembly 450, between the nip defined by the print head 460 and the platen roller 480, and out through the media exit 360. As illustrated, when the print head assembly 450 is disengaged from the platen roller 480, a loading gap 660 is created between the print head 460 and the platen roller 480 which allows a user to more easily feed the media web 612 from the media supply roll 610, past the media sensor 416, and through the print mechanism to the media exit 360. Conventionally, if the print head 460 does not disengage from the platen roller 480, the structure of the platen/print head nip can present a conflict in that tight tolerances between the print head 460 and the platen roller 480 assist in printing, but such tolerances may make it difficult for a user to insert the media web 612 between the print head 460 and the platen roller 480 during loading of the media web 612 into the media processing device 300.

FIG. 3 illustrates a side view of the media processing device 300 of FIG. 1 with a media supply roll 610 installed, according to at least one aspect of the present disclosure. The major door 322 of the access door assembly 320 is in the major support position exposing the internal cavity 306 and the printer chassis 308. The printer chassis 308 is a structural member configured to support some or all of the internal components of the media processing device 300. The internal components within the internal cavity 306 may also include a ribbon supply spindle 420 and a ribbon take-up spindle 430. The ribbon supply spindle 420 may be configured to hold a spool of the unused portion of a ribbon while the ribbon take-up spindle 430 may be configured to hold a spool of the used portion of the ribbon. Also illustrated is the media exit 360 through which printed media exits the media processing device 300. The printer chassis 308 holds the media spindle 410, ribbon supply spindle 420, ribbon take-up spindle 430, and the printing mechanisms 400 in place within the internal cavity 306.

In at least one aspect, the printed media on the media web 612 can be collected on a take-up roller 418. In this aspect, the media web 612 extends around the platen roller 480 and down toward the take-up roller 418. For example, the take-up roller 418 can move as the platen moves to collect media printed on the media web 612. Once all the desired media is printed, the media on the take-up roller 418 can be removed for later use.

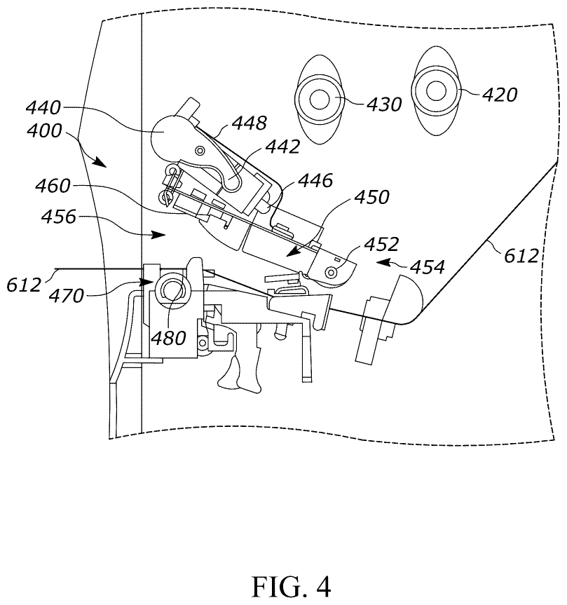

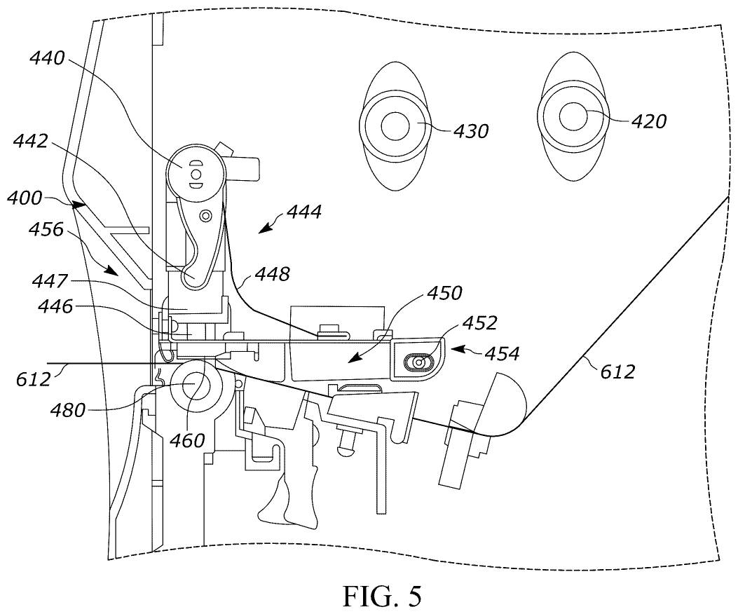

The printer chassis 308 may further hold a printing mechanism 400 as shown in detailed circle 4 which is further illustrated in FIGS. 4-7 depicting an enlarged view of the detailed circle 4 of FIG. 3. The printing mechanism 400 may include a print head assembly 450 including a print head 460, a platen assembly 470 including a platen roller 480, and a toggle assembly 440 including a toggle handle 442, biasing member 446, and a lift strap 448. The print head assembly 450 is illustrated in a loading position in FIG. 4 and a printing position in FIG. 5, both according to at least one aspect of the present disclosure. The print head 460 and the platen roller 480, when engaged, define a nip therebetween. In the printing position, the print head 460 engages the platen roller 480 along a print line.

The illustrated printing mechanism 500 may be configured for direct thermal printing by feeding a media element that includes a heat activated thermal coating through the nip and out the downstream end 456 of the print head assembly 450. The print head 460 is configured to supply heat to the media element causing the heat activated thermal coating to darken and show in specific locations on the media element. In at least one aspect, the print head 460 can heat the media element up to 300° C. Generally, the media element is heated to between 100° C.-120° C. during normal direct thermal printing operations.

The illustrated printing mechanism 400 may be configured for thermal transfer printing by feeding a media element and a printer ribbon through the nip and out the downstream end 456 of the print head assembly 450. The print head 460 may heat and compress the ribbon against the media element to deposit ink from the ribbon onto the media element. In at least one aspect, the print head 460 can heat the media element up to 300° C. Generally, the media element is heated to between 100° C.-120° C. during normal thermal transfer printing operations.

In at least one aspect, the print head assembly 450 of the printing mechanism 400 is pivotably attached along axis 452 to the printer chassis 308. The print head assembly 450 includes the print head 460 which is mounted to the print head assembly 450 with a retention spring mechanism as will be further detailed below. The toggle assembly 440 is pivotally attached to the printer chassis 308 and is configured to be manually rotated by a user via handle 442 between a disengaged position (FIG. 4) and an engaged position (FIG. 5). As the toggle assembly 440 is rotated from the disengaged position to the engaged position along arrow 444, the driving elements 446 drive the print head assembly 450 into the printing position. The driving elements 446 may include a curved profile configured to slidably engage a surface of the print head assembly 450 as the toggle assembly 440 is rotated along arrow 444. The curved profile of the driving elements may provide a cam-type functionality which moves along the print head assembly 450 as the toggle assembly 440 is rotated and drives the print head assembly 450 into the printing position. Thus, the contact areas between the driving elements 446 and the print head assembly 450 may be configured to allow a sliding motion as the toggle assembly is rotated to the engaged position. Detents within the toggle assembly 440 are configured to retain the toggle assembly in either the engaged position or the disengaged position. When the toggle assembly 440 is in the engaged position, the driving elements 446 hold the print head assembly 450 in the printing position with the print head 460 engaged with the platen roller 480. In response to the toggle assembly being moved from the engaged position of FIG. 5 to the disengaged position of FIG. 4, the driving elements 446 are disengaged from the print head assembly 450 and the lift strap 448 is configured to raise the print head assembly 450 out of the printing position and into the loading position.

The driving elements 446 may be adjusted such that the amount of pressure applied to the print head assembly 450 in the engaged position is variable. In at least one aspect, the pressure can range from 2-15 pounds per square inch based on the adjustment. For example, normal printing operations generally require pressure in the range of 2-8 pounds per square inch. The adjustment mechanism may be arranged within adjustment members 447 wherein the adjustment members 447 are configured to be moved between pre-defined positions. The movement may be achieved by rotating an end of the adjustment member 447 which either extends or retracts the driving element 446 dependent upon the direction of rotation. The adjustment members may be configured with indicators of the pre-defined positions to which the adjustment mechanism may be moved. The pre-defined positions may be indicated by figures, numbers, or other indicia that allows a user to easily interpret the effect of the adjustment (e.g., more pressure or less pressure). Further, embodiments which include multiple driving elements 446 may include an adjustment member 447 for each driving element 446. The pre-defined positions with marked indicia may be used to adjust the driving elements 446 to the same, or possibly different positions, resulting in different levels of pressure applied across the print head assembly 450 by the driving elements 446. Adjusting the driving elements 446 to a longer length results in greater pressure applied to the print head assembly 450, thereby increasing the pressure of the print head 460 against the platen roller 480. The adjustable driving elements 446 enable a user to adjust the print head pressure to optimize the print quality. In at least one aspect, the adjustable driving elements 446 may be adjusted manually by a user. In an alternative aspect, the adjustable driving elements 446 may be adjusted by motors coupled to a control circuit. In this aspect, the control circuit adjusts the driving elements based on an input.

The lift strap 448 may be attached at one end to the toggle assembly 440 and at the other end to the print head assembly 450. The lift strap 448 may be made of any flexible, high-tensile strength material with low elasticity, for instance a polyester film. In response to the toggle assembly 440 being moved from the engaged position of FIG. 5 to the disengaged position of FIG. 4, the toggle assembly 440 lifts the lift strap 448 to raise the print head assembly 450 from the printing position to the loading position. Further, the lift strap 448 suspends the print head assembly 450 in the loading position while the toggle assembly 440 is in the disengaged position.

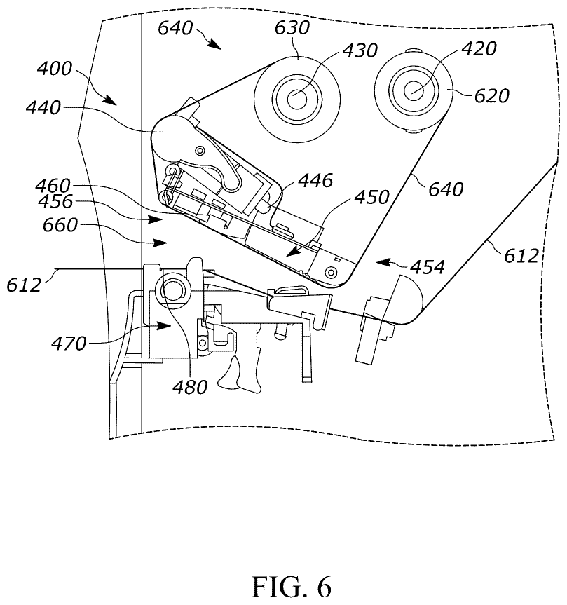

Thermal transfer printers use an ink ribbon that contains ink disposed on a substrate, where the ink is transferred to a media substrate of a media element via pressure and heat. Media processing devices according to example embodiments of the present invention may use any number of types of ribbons including dye ribbons, hologram ribbons, security material ribbons, and UV coating ribbons, among others. Therefore, in addition to the media substrate being loaded and aligned between the print head assembly 450 and the platen roller 480, the ink ribbon 640 must be similarly inserted between the print head 460 and the platen roller 480. FIG. 6 illustrates the printing mechanism 400 with a printer ribbon installed, according to at least one aspect of the present disclosure. The ink ribbon 640 includes a supply spool 620 and a take-up spool 630, each disposed on a respective spindle. The ink ribbon 640 is fed along an ink ribbon path extending from the supply spool 620, around the print head assembly 450, and past the print head 460. The ink ribbon 640 makes a relatively sharp upward transition after the print head 460 toward the toggle assembly 440, around which the ink ribbon bends to arrive at the take-up spool 630. The relatively sharp transition after the print head 460 provides a peel-mechanism whereby the ink ribbon is lifted from the media substrate at a sharp angle to reduce the flash or excess ink that may surround a printed image.

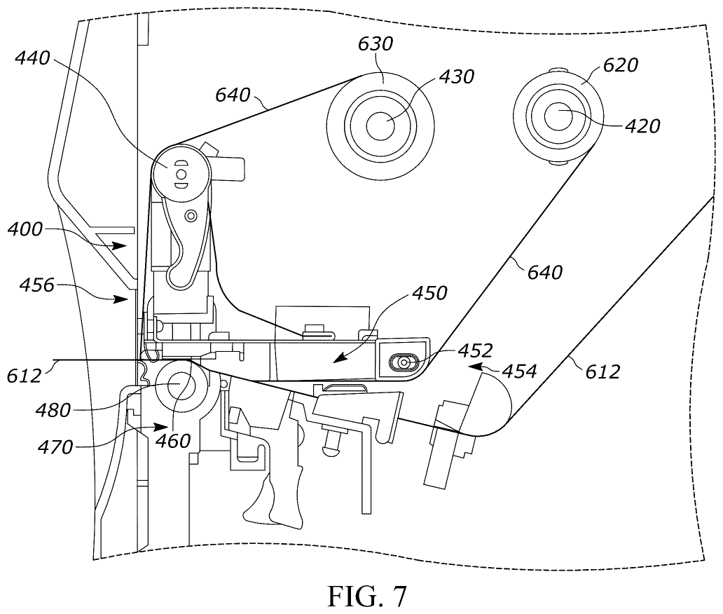

FIG. 6 illustrates the ink ribbon 640 installed onto the print mechanism and properly routed past the print head 460. As illustrated, the loading gap 660 created when the print head assembly 450 is disengaged from the platen roller 480 allows the ink ribbon 640 to be easily routed and aligned to the print head assembly 450. FIG. 7 illustrates the ink ribbon 640 as installed with the print head assembly 450 in the engaged position, according to at least one aspect of the present disclosure. As depicted, the path from the supply spool 620 to the take-up spool 630 is longer when the print head assembly 450 is in the printing position such that when the toggle assembly 440 is moved from the loading position to the printing position, tension is applied to the ink ribbon 640. The tension applied to the ink ribbon 640 is desirable and ensures that the ink ribbon 640 lays flat against the print head 460. Further, the tension applied to the ink ribbon 640 provides more consistent and repeatable alignment of the ribbon.

To perform a thermal transfer printing process, a media element of the media web 612 and an ink ribbon 640 are fed through the nip and out the downstream end 456 of the print head assembly 450. During the thermal transfer printing process, the print head 460 and platen roller 480 compress the ink ribbon 640 against the media element and the print head 460 provides heat to desired sections to deposit ink from the ink ribbon 640 at those desired sections onto the media element.

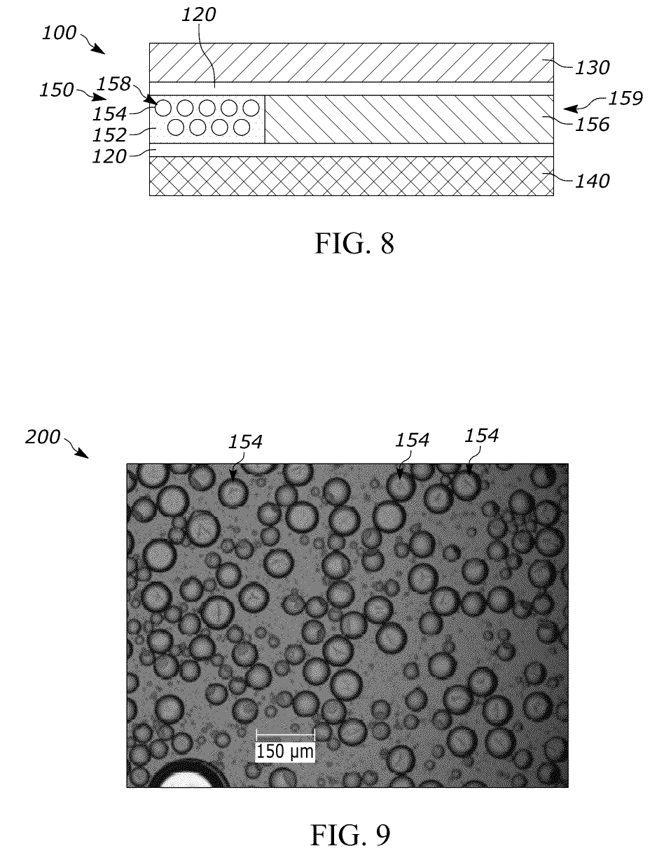

Microcapsules 154 encapsulating an indicator material 158 can be placed on or in a media element 100. Media element 100 is one non-limiting example of a media element. Some examples of media elements 100 that can include the encapsulated indicator material 158 can include, for example, labels, tags, wristbands, inlays, plastic cards, etc. For example, the microcapsules 154 can be placed on a surface of the media element 100. As another example, the microcapsules 154 can be placed in a layer within the media element 100. FIG. 8 illustrates a diagram of a cross-section of one example media element 100 including an environmental sensor 150, according to at least one aspect of the present disclosure. The media element 100 includes a printable substrate made of layers attached to each other with adhesive layers 120 (e.g., a face sheet layer composed of face sheet material 130, an environmental sensor layer 159, and a release layer composed by a release liner 140). In at least one aspect, one of the layers is a paper material. One of the layers is the environmental sensor layer 159 that includes microcapsules 154 encapsulating an indicator material 158 to form the environmental sensor 150 on the media element 100.

In some aspects, the environmental sensor layer 159 further includes a carrier material 152 surrounding the microcapsules 154. The carrier material 152 can be required for some methods of placing the microcapsules 154 onto the environmental sensor layer 159 of the media element 100. In an alternative aspect, the environmental sensor 150 is placed on the environmental sensor layer 159 without the carrier material 152. In some aspects, the media element 100 can include the face sheet 130 and can be devoid of the adhesive 120 and release liner 140.

Additionally, the environmental sensor layer 159 further includes a fill material 156 (e.g., to provide a generally uniform thickness of the media element 100). In some aspects, the fill material 156 can be part of the environmental sensor 150 (e.g. a wicking material to move the indicator material 158 along the substrate). In an additional/alternative aspect, the fill material 156 is mainly used to bridge the gap between layers formed by the thickness of the microcapsules 154 (e.g. the fill material can be face sheet 130 material) so that a thickness of the media element 100 is uniform. In at least one aspect, the face sheet 130 material is a paper material. In at least one aspect, the fill material 156 is based on the type of environmental sensor 150 attached to the media element 100.

In some aspects, the release liner 140 is selectively detachable from the media element 100 to expose one of the adhesive layers 120, which can include an adhesive that can be used to affix the media element 100 to an object. In an alternative aspect, the media element 100 is liner-less and does not include the release liner 140. In at least one aspect, the media element 100 includes a layer that is a face sheet 130 covering the layer 159 with the microcapsules 154. In some aspects, when the observable effect corresponds to a visual effect, the face sheet 130 can have more or one windows or openings through which a portion of the environmental sensor 150 and/or the environmental sensor layer 159 can be viewed. In at least one aspect, the face sheet 130 material is a paper material, polyester material, thermoplastic and/or vinyl polymer materials, such as polypropylene, polyethylene, polyethylene terephthalate, nylon, and/or Tyvek®, and/or any combination thereof. The media element 100 can be printed on through a thermal transfer printing process. In some aspects, the media element 100 includes a layer with a heat activated thermal coating (e.g., the face sheet 130 can include the heat activated thermal coating), which allows the media element 100 to be printed on using a direct thermal printing process. In some aspect, the media element 100 can include the face sheet and the sensor layer 159 and can be devoid of the adhesive layer 120 between the release liner 140 and the sensor layer and/or can be devoid of the release. In such instances, a second face sheet 130 can be included in the media element 100 such that the sensor layer 159 is disposed between first and second face sheets. Some examples of media elements 100 that can include the encapsulated indicator material 158 are labels, tags, wristbands, inlays, plastic cards, and etc.

The microcapsules 154 encapsulate an environmental indicator material 158. After the environmental indicator material 158 is exposed to a predetermined environmental condition, the environmental indicator material 158 can change from an initial material state to a second material state producing an observable effect. In at least one aspect, the change in material state from an initial material state to a second material state is a change in a property of the material, e.g. a state of matter, electrical conductivity, a color attributes, etc.

In at least one aspect, the microcapsules 154 prevent the observable effect from occurring in the environmental sensor 150 by protecting the environmental indicator material 158 from exposure to the predetermined environmental condition. For example, the environmental indicator material 158 can stay in the initial material state even if the microcapsules 154 are exposed to the predetermined environmental condition. However, after the microcapsules 154 are ruptured, the environmental indicator material 158 is released and any change in the material state of the environmental indicator material 158 upon exposure to the predetermined environmental condition can cause the observable effect to be produced by the environmental sensor 150. In an additional or alternative aspect, the microcapsules 154 prevent the observable effect from occurring in response to the predetermined environmental condition by containing the environmental indicator material 158 when it changes material state. For example, the environmental indicator material 158 can change material states within the microcapsule 154 but the observable effect can be prevented until the microcapsules 154 are ruptured releasing the environmental indicator material 158 and the released environmental indicator material 158 is exposed to the predetermined environmental condition (e.g., by preventing movement of the material when it liquefies, or by hiding a color change of the material).

In at least one aspect, a diameter of each microcapsule 154 is between 20 μm to 250 μm. The shell thickness of each microcapsule 154 can range between 5 μm to 25 μm. FIG. 9 illustrates an example view 200 of a microcapsules 154 of the environmental sensor 150 on the media element 100, according to at least one aspect of the present disclosure. The microcapsules 154 can be made of a variety of materials, e.g. urea formaldehyde, gelatin, protein, melamine, polyurea formaldehyde, gel, polymelamine formaldehyde, wax material, emulsions, etc. For example, polymelamine and polyurea formaldehyde are both used for encapsulations by interfavial polymerization which uses two immiscible phases. Once separated in the same vessel, a reaction is initiated at the interface of the two immiscible phases in the presence of an initiator and the material to be encapsulated. As polymerization occurs, microcapsules 154 form around the core material. The microcapsules 154 release the environmental indicator material 158 upon rupturing the microcapsules 154.

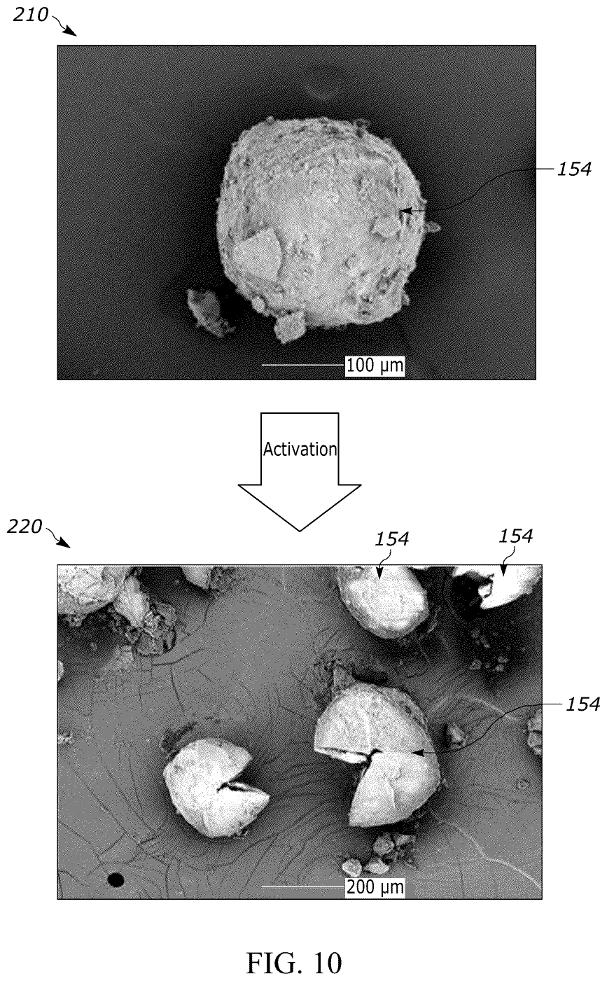

FIG. 10 illustrates a microcapsule rupturing after an activation process, according to at least one aspect of the present disclosure. The view 210 illustrates a microcapsule 154 before activation and view 220 illustrates a ruptured microcapsule after activation that released the environmental indicator material 158.

In at least one aspect, at least a portion of the microcapsules 154 are ruptured based on a force applied to the microcapsules 154, where the force exceeds or equals a predetermined threshold. The value of the predetermined threshold is based on the microcapsule material, thickness of the microcapsules 154, and/or the diameter of the microcapsules 154. The force can be a pressure force, a shear force, a frictional force, and/or a cutting force that cause at least a portion of the microcapsules 154 to rupture. In at least one aspect, the force is a pressure force and the predetermined threshold is between 1.5 pounds per square inch and 8 pounds per square inch. In an alternative aspect, the force is a pressure force and the predetermined threshold is between 4 pounds per square inch and 15 pounds per square inch. In yet another alternative aspect, the force is a pressure force and the predetermined threshold is between 16 pounds per square inch and 21 pounds per square inch.

In at least one aspect, the portion of the microcapsules 154 are ruptured based, in part, on a temperature of the microcapsules 154, where the temperature of the microcapsules 154 exceeds or is equal to a predetermined temperature threshold. For example, temperature increases can cause the microcapsules 154 to rupture based on a minor amount of force being applied to the microcapsules 154. The value of the predetermined temperature threshold is based on the microcapsule material, the thickness of microcapsules 154, and/or the diameter of the microcapsules 154. In at least one aspect, the predetermined temperature threshold is between 90° C. and 110° C. In an alternative aspect, the predetermined temperature threshold is between 90° C. and 250° C.

In at least one aspect, at least a portion of the microcapsules 154 are ruptured based on both a force applied to the microcapsules 154 and a temperature of the microcapsules 154, where the force exceeds or equals a predetermined threshold and the temperature of the microcapsules 154 exceeds or is equal to a predetermined temperature threshold. The force can be a pressure force, a shear force, a frictional force, or a cutting force that cause at least a portion of the microcapsules 154 to rupture. In at least one aspect, the predetermined temperature threshold is between 90° C. and 110° C., the force is a pressure force, and the predetermined threshold is between 4 pounds per square inch and 15 pounds per square inch. In an alternative aspect, the predetermined threshold is between 1.5 pounds per square inch and 8 pounds per square inch.

In at least one aspect, each microcapsule 154 of the microcapsules 154 can have a first shell wall and a second shell wall encapsulating the environmental indicator material 158. For example, the first shell wall surrounds the environmental indicator material 158 and the second shell wall surrounds the first shell wall. Stated another way, there are two coating to each microcapsule 154 that surround the environmental indicator material 158. The first shell wall is configured to rupture based, in part, on a temperature being equal to or greater than a predetermined temperature threshold. The second shell wall is configured to rupture based on a force equal to or greater than a predetermined threshold being applied to the microcapsules 154. As discussed above, the force can be a pressure force, a shear force, a frictional force, or a cutting force that causes at least a portion of the microcapsules 154 to rupture. In this aspect, both heat and a force would need to be applied to the microcapsules 154 for at least a portion of microcapsules 154 to rupture.

The microcapsules 154 are configured to rupture in response to heat and/or force, and contain environmental indicator materials 158, e.g., the microcapsules 154 described in the commonly owned applications: U.S. patent application titled “PRINTER ACTIVATABLE ENVIRONMENTAL SENSING THROUGH CHEMICAL ENCAPSULATION”, Attorney Docket No. 0820887.00357; and U.S. patent application, titled “USE OF ENCAPSULATED POLAR PROTIC CHEMISTRIES FOR RFID TEMPERATURE MONITORING”, Attorney Docket No. 0820887.00355, both filed concurrently with this application.

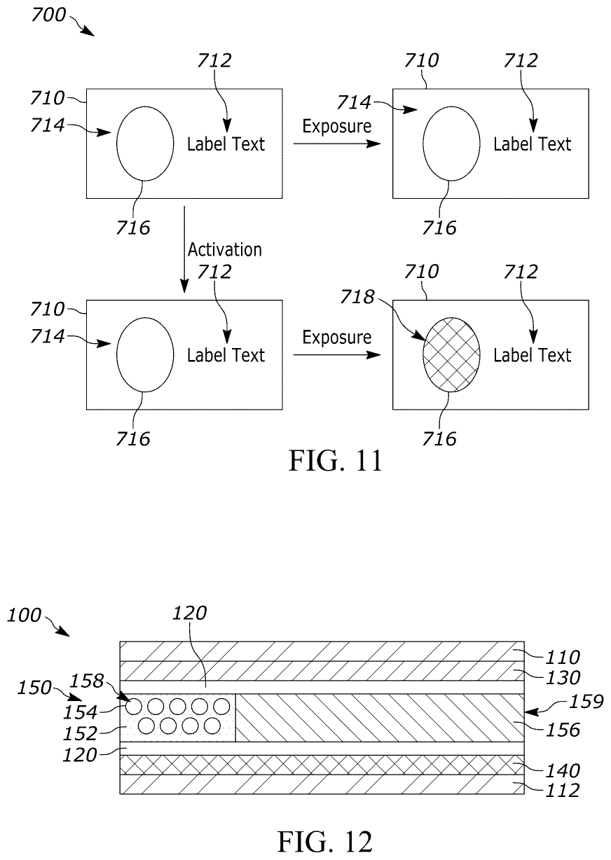

FIG. 11 illustrates a diagram 700 showing a media element 710 exposed to the predetermined environmental condition before and after activation, according to at least one aspect of the present disclosure. The media element 710 is substantially similar to media element 100. For the sake of brevity not all similarities will be discussed in detail. The media element 710 includes label text 712 and an environmental sensor 716. The environmental sensor 716 is substantially similar to environmental sensor 150 and for the sake of brevity not all similarities will be discussed in detail. The environmental sensor 716 begins in a non-activated configuration, where the environmental sensor 716 is in an initial sensor state 714 before activation and exposure. After an activation process, the environmental sensor 716 is placed in the activated configuration, where the environmental indicator material 158 in the environmental sensor 716 has been released from at least a portion of the microcapsules 154. When the released environmental indicator material 158 is exposed to the predetermined environmental condition, then the environmental sensor 716 transitions from the initial sensor state 714 to a second sensor state 718. In at least one aspect, before activation, the environmental sensor 716 does not change sensor states even when exposed to the predetermined environmental condition.

The environmental indicator material 158 encapsulated in the microcapsules 154 can be different based on the desired environmental sensor 150 or 716. The environmental indicator material 158 can be a polymer, a polymer having side-chain crystallinity, an alkane wax, a polar protic material, a wax with a colorant, a gel with a colorant, an acid, a base, etc., or a combination thereof. Some example polar protic materials are polyethylene glycol, decanol, undecanol, dodecanol, and tridecanol. The type of environmental indicator material 158 used relates to the type of environmental sensor 150 or 716. Which allows the environmental indicator material 158 to be responsive to the appropriate predetermined environmental condition for the type of environmental sensor 150 or 716 desired. Some example predetermined environmental conditions are as follows: a temperature excursion above a predetermined temperature threshold for at least a predetermined amount of time, a temperature excursion below a predetermined temperature for at least a predetermined amount of time, a cumulative exposure to temperature over a time period above a predetermined threshold for at least a predetermined amount of time, an exposure to a particular chemical, an oxygen exposure, an ammonia exposure, an exposure to a particular chemical above a threshold concentration, an exposure to a particular chemical above the threshold concentration for at least a predetermined amount of time, an exposure to at least a predetermined amount of radiation of a particular type, an ultraviolet light exposure, a humidity exposure, an exposure to a humidity level above a predetermined threshold, an exposure to a humidity level above a predetermined threshold for at least a predetermined amount of time, and etc.

Once the environmental indicator material 158 is released from at least a portion of the microcapsules 154 (i.e. after an activation process ruptures the microcapsules 154) and exposed to the predetermined environmental condition, then the released environmental indicator material 158 changes from an initial material state (e.g. corresponding to the initial sensor state 714) to a second material state (e.g. corresponding to the second sensor state 718) producing an observable effect. The observable effect can be one of a color state change, a change in transparency, a change in hue, a change in an electrical property, a change in conductivity, a change in capacitance, movement of the environmental indicator material 158 along a substrate, etc., or combinations thereof. In at least one aspect, the observable effect can be a continuous transition; however, once a threshold is met, the environmental sensor 150 or 716 would be considered to go from the initial sensor state to the second sensor state.

The observable effect is different based on the environmental indicator material 158 and the design of the media element 100 or 710. For example, an observable effect of movement of the environmental indicator material 158 along a substrate of the media element 100 or 710 can be caused by the substrate including a wick that allows a liquid environmental indicator material 158 to move along the wick (e.g., the environmental indicator material 158 can be liquid or have increased fluidity in the second material state). As another example, a change in an electrical property can be caused by an environmental indicator material 158 that melts above a specific temperature, which then allows the material to change an electrical property of a device, for example altering a dielectric in a capacitor changing capacitance, or, with a conductive liquid, completing or breaking a circuit built into the substrate of the media element 100 or 710, which changes the electrical property.

FIG. 12 illustrates a diagram of an example media element 100 passing between activation mechanism components 110, 112, according to at least one aspect of the present disclosure. In at least one aspect, the activation mechanism components 110, 112 cause at least a portion of the microcapsules 154 to rupture as the media element 100 is between activation mechanism components 110, 112. For example, a media processing device can be the activation mechanism and media processing components (e.g. print head 460 and platen roller 480) can be the activation mechanism components 110, 112 that supply the force and/or temperature needed to cause at least a portion of the microcapsules 154 to rupture. Stated another way, the media processing components can be the activation mechanism components 110, 112 that supply a pressure to the media element 100 above the predetermined threshold, which in turn causes at least a portion of the microcapsules 154 to rupture releasing the environmental indicator material 158. In this aspect, the activation mechanism components 110, 112 can supply a pressure of 13 pounds per square inch with the predetermined threshold being 8 pounds per square inch, which would cause a portion of the microcapsules 154 to rupture.

In an alternative aspect, the activation mechanism can be a user's hand and the user can apply a force to the media element 100 with the user's fingers making the fingers be the activation mechanism components 110, 112. In this aspect, the predetermined threshold can be 20 pounds per square inch and the user's hand can supply a pressure greater than 20 pounds per square inch causing at least a portion of the microcapsules 154 to rupture.

The releasing of the environmental indicator material 158 transitions the environmental sensor 150 on the media element 100 from a non-activated configuration to an activated configuration. Once in the activated configuration, the environmental sensor 150 can change from an initial sensor state to a second sensor state upon exposure of the environmental indicator material 158 to the predetermined environmental condition. In some aspects, the activation mechanism components 110, 112 can be part of the printing assembly of a media processing device, e.g. printing assembly 400 of media processing device 300. In some alternative aspects, the activation mechanism components 110, 112 can be part of an activation mechanism located upstream or downstream of the printing assembly 400 in the media processing device 300.

In at least one aspect, the activation mechanism components 110, 112 can be the print head 460 and the platen roller 480, respectively. For example, as a media element 100 with an environmental sensor 150 passes between the platen roller 480 and print head 460, the media processing device 300 applies a force on the media element 100 through the platen roller 480 and the print head 460. The force applied by the platen roller 480 and the print head 460 to the media element 100 is greater than or equal to the predetermined threshold such that at least a portion of the microcapsules 154 in the environmental sensor 150 are ruptured. In at least one aspect, the force is a pressure. For example, the predetermined threshold can be 5 pounds per square inch and the platen roller 480 and the print head 460 can supply a force of 8 pounds per square inch to the media element 100 causing a portion of the microcapsules 154 to rupture.

In at least one aspect, the media element 100 can be printed with a thermal transfer printing process and the force applied by the platen roller 480 and the print head 460 to the media element 100 during the thermal transfer printing process can rupture at least a portion of the microcapsules 154 in the environmental sensor 150 on the media element 100. As such, the environmental sensor 150 on the media element 100 can transition from the non-activated configuration to the activated configuration during the thermal transfer printing process.

In at least one aspect, the media element 100 includes a heat activated thermal coating. In this aspect, the media element 100 can be printed with a direct thermal printing process and the force applied by the platen roller 480 and the print head 460 to the media element 100 during the direct thermal printing process can rupture at least a portion of the microcapsules 154 in the environmental sensor 150 on the media element 100. As such, the environmental sensor 150 on the media element 100 can transition from the non-activated configuration to the activated configuration during the direct thermal printing process.

In at least one aspect, at least a portion of the microcapsules 154 are ruptured based on both a force applied to the microcapsules 154 and a temperature of the microcapsules 154, where the force exceeds or equals a predetermined threshold and the temperature of the microcapsules 154 exceeds or is equal to a predetermined temperature threshold. In this aspect, the print head 460 is configured to apply the heat required to raise the temperature of the microcapsules 154 above the predetermined temperature threshold and the print head 460 and platen roller 480 can apply a force to the microcapsules 154 as a media element 100 passed between the print head 460 and platen roller 480.

The force required to be applied by the media processing components 110, 112 on the media element 100 to rupture the microcapsules 154 can be reduced if a bursting additive 160 (e.g., an textured material) is added to the media element 100. In at least one aspect, an abrasiveness of the bursting additive 160 causes the microcapsules 154 to rupture at a lower force from the media processing components 110, 112. For example, the predetermined threshold force needed to be applied to the microcapsules 154 by a device (e.g., a media processing device, such as a printer) or a user for at least a portion of the microcapsules 154 to rupture can be 15 pounds per square inch without the bursting additive 160 and the predetermined threshold force can be 8 pounds per square inch with the bursting additive 160. As such, more microcapsules 154 can be ruptured at the same force with the bursting additive 160 in the media element 100, than with no bursting additive 160 in the media element 100. Thus, having the bursting additive 160 in the media element 100 can increase the amount of microcapsules 154 that are ruptured as the media element 100 passes through the media processing device 300.

A method to form an activatable media element 100 is to add microcapsules 154 to a printable media substrate, e.g. as shown on media element 100. Each microcapsule 154 contains an environmental indicator material 158 as discussed in regard to FIGS. 8-11. The environmental indicator material 158 is configured, in response to exposure to a predetermined environmental condition after being released from the microcapsules 154, to change from an initial state to a second state producing an observable effect. The intact microcapsules 154 are in a non-activated configuration and when ruptured the microcapsules 154 releases the environmental indicator material 158 placing the microcapsules 154 in an activated configuration. In at least one aspect, the microcapsules 154 prevent an occurrence of the observable effect in the environmental sensor 150 while in the non-activated configuration and allow the occurrence of the observable effect in the environmental sensor 150 in the activated configuration when the released environmental indicator material 158 is exposed to the predetermined environmental condition after at least a portion of the microcapsules 154 are ruptured.

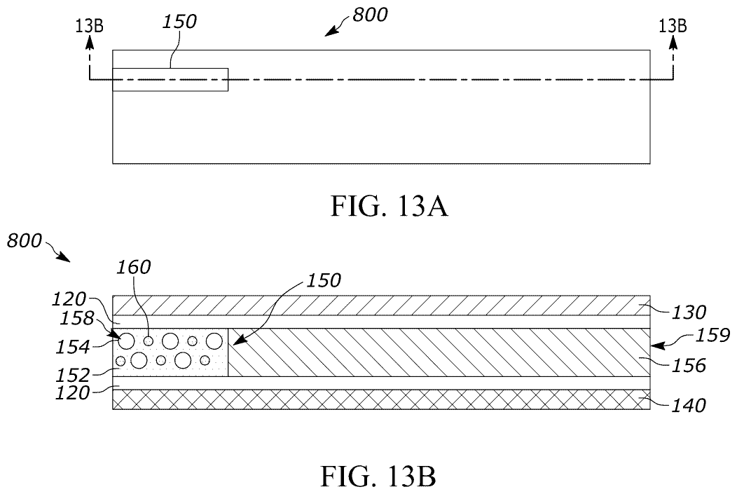

The method further includes adding the bursting additive 160 proximate the microcapsules 154. In at least one aspect, the bursting additive 160 and the microcapsules 154 are added in the same layer at the same location of the printable media substrate (see FIG. 13B). In an alternative aspect, the bursting additive 160 is added to one layer of the printable substrate and the microcapsules 154 are added to a different layer of the printable substrate. In this aspect, the bursting additive 160 and the microcapsules 154 are aligned such that they span the same area on the printable substrate. In yet another alternative aspect, the bursting additive 160 is added to a release liner attached to the printable substrate. In this aspect, the bursting additive 160 and the microcapsules 154 are aligned such that they span the same area on the media element 100. In another aspect, the media element 100 can include a bursting additive layer 164 that includes the bursting additive 160, where the bursting additive layer 164 can be disposed adjacent to the environmental sensor layer 159.

The bursting additive 160 being proximate the microcapsules 154 allows the bursting additive 160 to selectively interact with the microcapsule to rupture the microcapsules 154 when a force is applied to the microcapsules 154 and bursting additive 160. In at least one aspect, the bursting additive 160 is made of an textured material. The textured material can form an abrasive, rough, non-uniform, variable, and/or jagged surface that increase the strain on the individual microcapsules 154 due to a pressure force, shear force, cutting force, and/or friction force caused by the textured material interacting with the individual microcapsules 154 in response to a force (e.g. pressure) being applied to the media element 100. In some aspects, the bursting additive 160 reduces the amount of force required to be applied to the media element 100 to rupture a portion of the microcapsules 154. This process can reduce the predetermined threshold making it easier for the activation mechanism to rupture a portion of the microcapsules 154 and placed the environmental sensor 150 in the activated configuration.

In at least one aspect, the textured material of the bursting additive 160 can create an uneven surface that is pressed against the microcapsules 154 causing a higher friction force, shear force, cutting force, and/or pressure force on the individual microcapsules 154 increasing the strain on the individual microcapsules 154 causing them to rupture at a lower force than without the textured material of the bursting additive 160. In an additional or alternative aspect, the textured material of the bursting additive 160 increases the hardness of the media element 100 at the location of the bursting additive 160. For example, the textured material of the bursting additive 160 can span an area on the media element 100 and the abrasive material increases the hardness (or stiffness) of the media element 100 in that area. Increasing the hardness at the location of the microcapsules 154 can increase the strain applied to each individual microcapsules 154 from a force applied to the microcapsules 154. The increased strain from the hardness of the textured material can cause the microcapsules 154 to rupture at a lower applied force than on a media element 100 without the textured material. In at least one aspect, the hardness at the area of the microcapsules 154 can be increased to greater than or equal to a 2 on the Mohs hardness scale. In at least one aspect, the hardness is between 1 and 10 on the Mohs hardness scale.

In at least one aspect, the bursting additive 160 increases an effective force applied to the individual microcapsules 154 of the microcapsules 154. For example, a pressure force can be applied to the microcapsules 154 and the bursting additive 160 can increase and effective force applied to the individual microcapsules 154 of the microcapsules 154 by anywhere up to fifteen pounds per square inch depending on the material properties of the bursting additive 160. In this instance of a pressure force being applied, the pressure required to be applied to the media element 100 in order to burst the microcapsules 154 can be reduced by up to ninety percent depending on the material properties of the bursting additive 160.

Some example textured materials for a bursting additive 160 the can be added to a media element 100 are sandpaper of various grits from 60 grit to 300 grit, microneedles, metallic particles, silica particles, glass particles, plastic particles, stone paper, a plastic/nylon mesh, steel wool, and natural and mineral abrasives (e.g. in the form of particles) such as sand, silicon dioxide, silica, silicate, silicon carbide, quartz, talc, alumina, borax, baking soda, quartz, garnet, emery, sandstone, powdered feldspar, salts, etc. In at least one aspect, the particles are harder than the microcapsules. If microneedles are used in the abrasive material then they can have a length of 150-1500 micrometers, 50-250 micrometers wide, and 1-25 micrometers in diameter. The microneedles are typically made of silicon, stainless steel, sugar, or polymers. The microneedles can be solid, coated, hollow, or dissolvable. In at least one aspect, the abrasive material is made of particles that have a diameter length in the range of 25 nanometers to 500 micrometers.

In at least one aspect, the predetermined threshold force is different based on which abrasive material is used or what the initial encapsulation is comprised of, as well as the environment of the encapsulation.

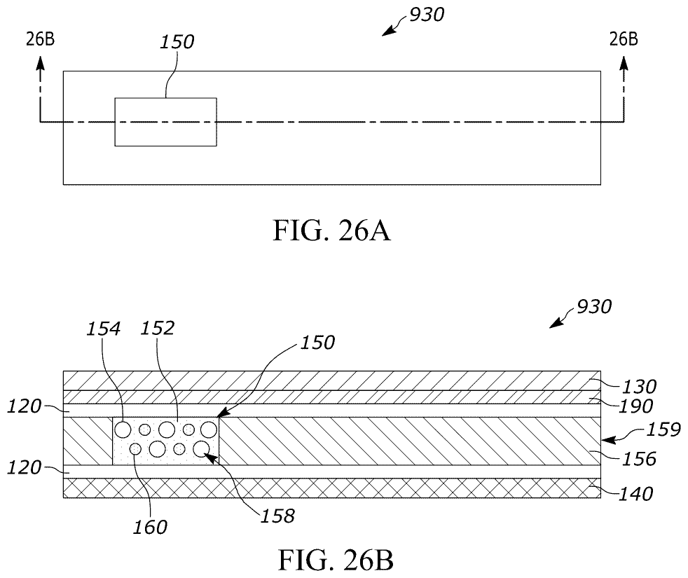

The bursting additive 160 can be added to a media element in different locations. FIGS. 13A-25B are diagrams that illustrate media elements 800, 810, 820, 830, 840, 850, 860, 870, 880, 890, 900, 910, and 920 that include microcapsules 154 and a bursting additive 160 and FIGS. 26A-35B illustrate media elements 930, 940, 950, 960, 970, 980, 990, 1000, 1010, 1020 with a heat activated thermal coating 190 and microcapsules 154 and a bursting additive 160. The adhesive layers 120, face sheet 130, release liner 140, environmental sensor 150, carrier material 152, microcapsules 154, and fill material 156 of media elements 800, 810, 820, 830, 840, 850, 860, 870, 880, 890, 900, 910, 920, 930, 940, 950, 960, 970, 980, 990, 1000, 1010, 1020 are substantially similar to those in media element 100. For the sake of brevity the similarities between the media elements 800, 810, 820, 830, 840, 850, 860, 870, 880, 890, 900, 910, 920, 930, 940, 950, 960, 970, 980, 990, 1000, 1010, 1020 and media element 100 will not be discussed in detail. The example media elements shown in FIGS. 13A-35B are not meant to be limiting and are noted as not being all the possible permutations of placing a bursting additive 160 and microcapsules 154 in a media element. For example, concepts of the different media element examples can be combined together to form a new media element example as will be discussed in more detail herein.

FIGS. 13A and 13B illustrate a diagram of a media element 800 with microcapsules 154 and a bursting additive 160 positioned in the same layer of a printable substrate, according to at least one aspect of the present disclosure. FIG. 13A shows the media element 800 with an environmental sensor 150 on the media element. The environmental sensor 150 can be positioned, sized, and shaped in any manner desired by a user. The media element 810 can be printed with a printing process in any area of the media element including the area covered by the environmental sensor 150. Currently, the media element 810 is configured for a thermal transfer printing process; however, a direct thermal printing process can be performed if a heat activated thermal coating was added (see FIGS. 26A-35B).

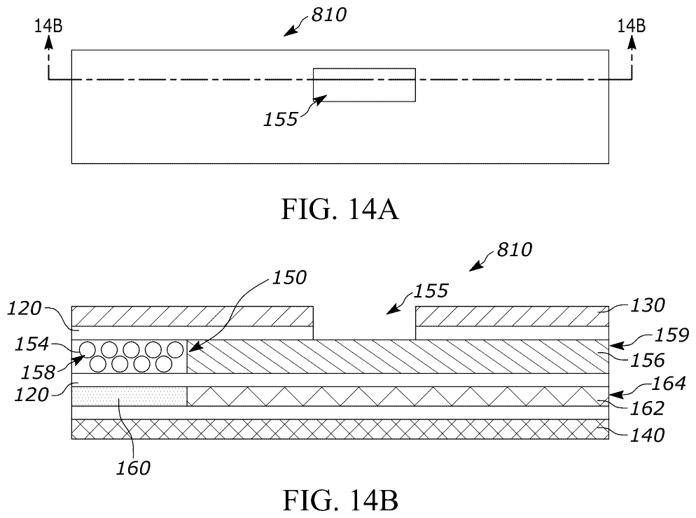

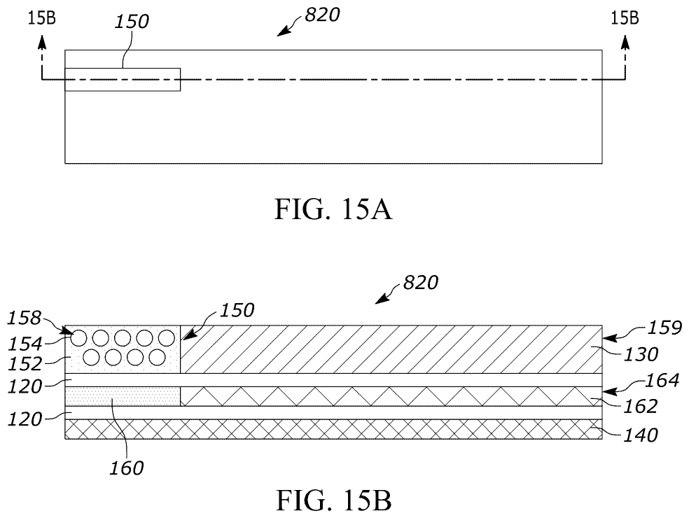

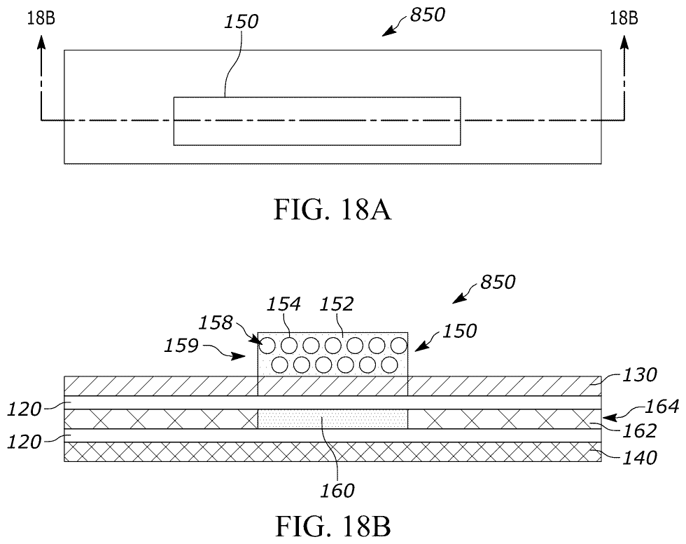

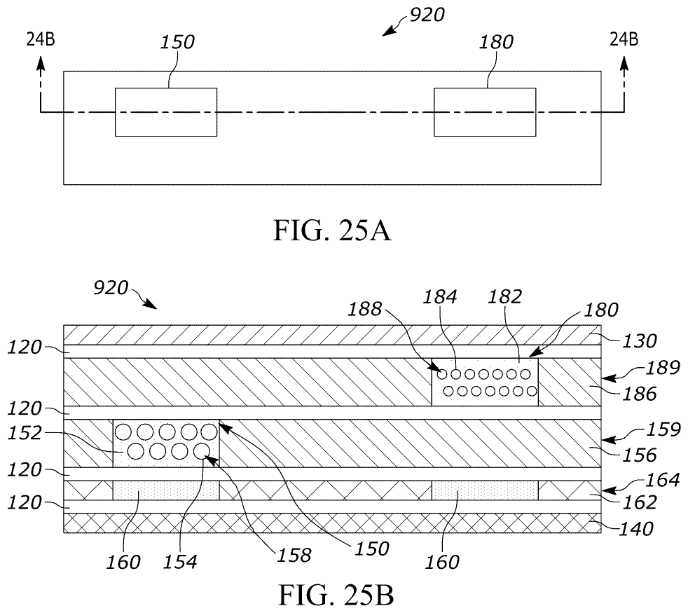

FIG. 13B illustrates a diagram of a cross-section of the media element 800 taken along the cross-section line shown in FIG. 13A. The media element 800 includes a printable substrate made of layers attached to each other with adhesive layers 120. The environmental sensor 150 includes microcapsules 154 and a bursting additive 160. For example, the bursting additive 160 can be dispersed or mixed with the microcapsules 154. In some aspects, the environmental sensor 150 further includes a carrier material 152 surrounding the microcapsules 154 and/or the bursting additive 160. The carrier material 152 can be required for some methods of placing the microcapsules 154 onto the environmental sensor layer 159 of the media element 800. In an alternative aspect, the environmental sensor 150 is placed on a layer 159 of the printable substrate without the carrier material 152. The environmental sensor layer 159 further includes a fill material 156. In some aspects, the fill material 156 can be part of the environmental sensor (e.g. a wicking material to move the indicator material 158 along the substrate, see FIG. 14B). In an additional/alternative aspect, the fill material 156 is mainly used to just bridge the gap between layers formed by the thickness of the microcapsules 154 (e.g. the fill material 156 can be face sheet 130 material). For example, the fill material 156 can ensure the media element 100 has a generally uniform thickness. In some aspects, a release liner 140 is attached to the printable substrate. In an alternative aspect, the media element 800 is liner-less and does not include a release liner 140 (see FIG. 25B). In at least one aspect, the media element 800 includes a layer that is a face sheet 130 covering the environmental sensor layer 159. In an alternative aspect, the media element 800 can have the environmental sensor 150 positioned within the top layer surrounded by face sheet 130 (See FIG. 15B) or the environmental sensor 150 can be attached to the face sheet 130 (see FIG. 18B).

FIGS. 14A, 15A, 16A, 17A, 18A, 19A, 20A, 21A, 22A, 23A, 24A, and 25A show media elements 810, 820, 830, 840, 850, 860, 870, 880, 890, 900, 910, and 920 respectively, that have an environmental sensor 150 positioned in different locations, sizes, and shapes. The environmental sensor 150 can be positioned, sized, and shaped, in any manner desired by the user. The media elements 810, 820, 830, 840, 850, 860, 870, 880, 890, 900, 910, and 920 can be printed with a thermal transfer printing process or direct thermal printing process in any area of the media elements including the area covered by the environmental sensor 150 as discussed in regard to FIGS. 13A and 13B. For a direct thermal printing process to be performed a heat activated thermal coating is added to the media element 810, 820, 830, 840, 850, 860, 870, 880, 890, 900, 910, and 920 (see FIGS. 26A-35B for some example media elements with heat activated thermal coating).

FIGS. 14A to 20B illustrate different diagrams of media elements 810, 820, 830, 840, 850, 860, and 870, respectively, with microcapsules 154 in one layer of the printable substrate and a bursting additive 160 in a different layer of the printable substrate, according to at least one aspect of the present disclosure.

FIG. 14B illustrates a diagram of a cross-section of the media element 810 taken along the cross-section line shown in FIG. 14A, according to at least one aspect of the present disclosure. The media element 810 includes a printable substrate made of layers attached to each other with adhesive layers 120. The media element 810 includes a release line 140 and a face sheet 130. In an alternative aspect, the media element 810 is liner-less and does not include a release liner 140 (see FIG. 25B). In at least one aspect, the face sheet 130 can be printed on with a thermal transfer printing process.

The environmental sensor 150 includes microcapsules 154. The media element 810 does not include a carrier material in the environmental sensor. In some alternative aspects, the carrier material can be included in the environmental sensor 150 of the media element 810 to surround the microcapsules 154. For example, some methods of placing the microcapsules 154 onto the layer of the printable substrate require a carrier material.

Media element 810 includes a window 155 that allows an observable effect to be seen through the top sheet 130. In some aspects, the top sheet 130 can be opaque and not show any of the layers below the top sheet 130. In an alternative aspect, the top sheet 130 can be transparent allowing layers below the top sheet 130 to be visible. In yet another aspect, the top sheet 130 can be partially opaque/transparent or a combination of both (e.g. transparent in one area and opaque in another area). In yet another alternative aspect, the top sheet 130 can be transparent and covered with an ink except for a portion that forms a window 155 to view an observable effect. The sensor layer 159 with the environmental sensor 150 further includes a fill material 156. In some aspects, the fill material 156 can be part of the environmental sensor 150. Referring to FIG. 14B, the fill material 156 can include a wicking material (e.g. a portion of the fill material 156 can be a wicking material) that can move the indicator material 158 along the substrate and to the window 155. As such, once in the activated configuration, the indicator material 158 can move along the wick to the window 155. As shown in FIG. 14B, the window 155 can allow the indicator material 158 access to the environment (e.g. for a humidity environmental sensor where the indicator material 158 needs exposed to the air humidity). In an additional/alternative aspect, the fill material 156 is mainly used to bridge the gap between layers formed by the thickness of the microcapsules 154 (e.g. the fill material 156 can be face sheet 130 material).

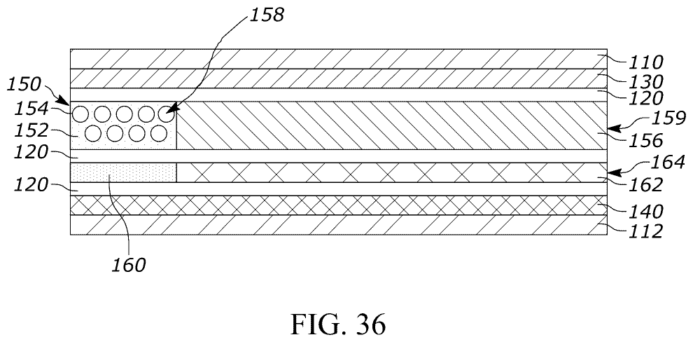

FIG. 14B shows the bursting additive 160 being added to a different layer of the printable substrate (e.g., a bursting additive layer 164) than the sensor layer 159 with the environmental sensor 150. Similar to the environmental sensor layer 159, the bursting additive layer 164 includes a fill material 162. The fill material 162 fills in the gap between layers formed by the thickness of the bursting additive 160 (e.g., so that the media element 810 has a generally uniform thickness). In at least one aspect, the fill material 162 is face sheet 130 material. In at least one aspect, the bursting additive layer 164 is attached to the sensor layer 159 with the environmental sensor 150. In an alternative aspect, any number of layers can be attached between the sensor layer 159 with the environmental sensor 150 and the bursting additive layer 164. The area of the media element 810 with the bursting additive 160 is aligned with the area of the media element 810 with the environmental sensor 150. For example, when looking at a top view of the media element (as shown in FIG. 14A), the area covered by the environmental sensor 150 is also covered by the bursting additive 160. This allows the bursting additive 160 to selectively interact with the microcapsules 154 in the environmental sensor 150 when a force is applied to the media element from an activation mechanism (see FIG. 36). For example, a force applied to the top and bottom of the media element 810 would cause the bursting additive 160 to interact with the microcapsules 154.

FIG. 15B illustrates a diagram of a cross-section of the media element 820 taken along the cross-section line shown in FIG. 15A, according to at least one aspect of the present disclosure. Media element 820 is substantially similar to media element 810 and for the sake of brevity not all the similarities will be discussed in detail. The environmental sensor 150 of media element 820 includes a carrier material 152 surrounding the microcapsules 154 as discussed in regard to FIGS. 12-13B. In an alternative aspect, the environmental sensor 150 is placed on a layer of the printable substrate without the carrier material 152 as discussed in regard to FIG. 14B. The media element 820 illustrates the environmental sensor 150 positioned into a layer along with face sheet 130. For example, the environmental sensor 150 can be positioned within the top layer and surrounded by face sheet 130.

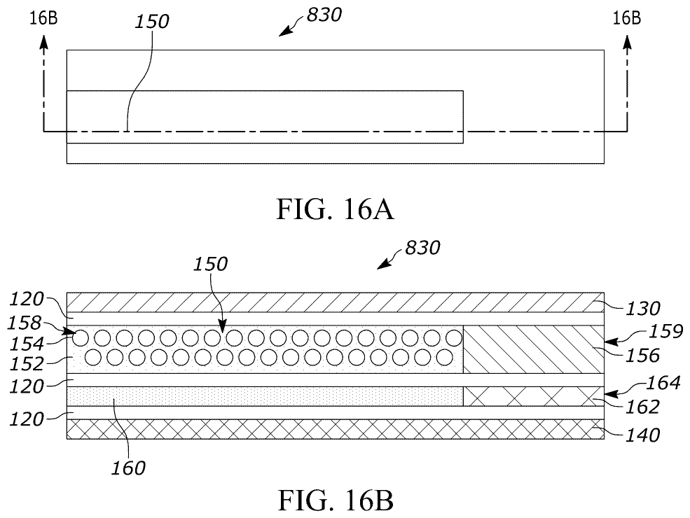

FIG. 16B illustrates a diagram of a cross-section of the media element 830 taken along the cross-section line shown in FIG. 16A, according to at least one aspect of the present disclosure. Media element 830 is substantially similar to media elements 810 and 820, and for the sake of brevity not all the similarities will be discussed in detail. FIG. 18B illustrates that the area of the media element 830 covered by the environmental sensor 150 can be any desired size. The media element 830 shows the environmental sensor 150 having a larger size than in media element 820. The area covered by the bursting additive 160 would increase to at least match the area covered by the environmental sensor 150. The bursting additive 160 is aligned with the environmental sensor 150 as discussed above in regard to FIG. 14B.

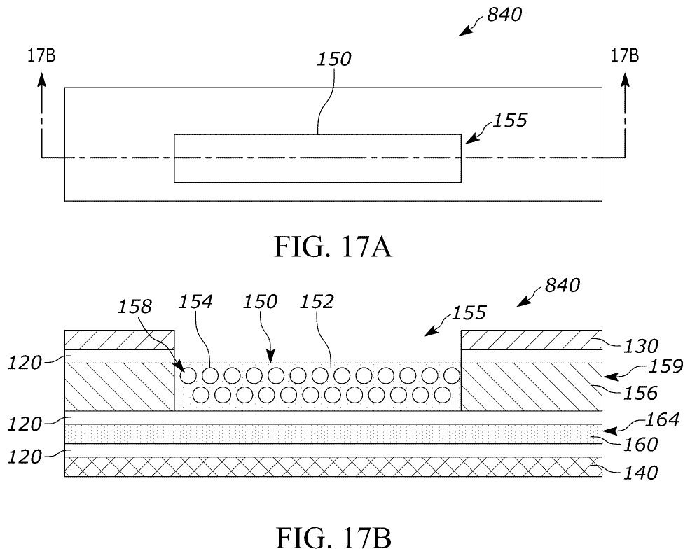

FIG. 17B illustrates a diagram of a cross-section of the media element 840 taken along the cross-section line shown in FIG. 17A, according to at least one aspect of the present disclosure. Media element 840 is substantially similar to media elements 810, 820, and 830, and for the sake of brevity not all the similarities will be discussed in detail. FIG. 17B illustrates that the area on the media element 840 covered by the bursting additive 160 can be larger than the area covered by the environmental sensor 150. In at least one aspect, the bursting additive 160 covers the entire area of the media element 840. In an alternative aspect, the bursting additive 160 covers an area larger than the environmental sensor 150 with the remaining area outside of the bursting additive 160 being covered with fill material 162. In yet another aspect, the bursting additive 160 can cover the same area as the environmental sensor as discussed in regard to FIG. 14B. In each of these aspects, the bursting additive 160 is aligned with the environmental sensor 150 since the area covered by the environmental sensor 150 in one layer is also covered by bursting additive 160 in a different layer.

Media element 840 includes a window 155 that allows an observable effect to be seen through the top sheet 130. Similar to FIG. 14B, the window 155 can allow the indicator material 158 access to the environment (e.g. for a humidity environmental sensor where the indicator material 158 needs exposed to the air humidity). As discussed in regard to FIG. 14B, the top sheet 130 can be opaque, transparent, or partially opaque/transparent.

FIG. 18B illustrates a diagram of a cross-section of the media element 830 taken along the cross-section line shown in FIG. 18A, according to at least one aspect of the present disclosure. Media element 850 is substantially similar to media elements 810, 820, 830 and 840, and for the sake of brevity not all the similarities will be discussed in detail. FIG. 18B illustrates that the environmental sensor 150 can be attached to the face sheet 130 layer. The environmental sensor 150 can be attached to any location on the face sheet 130 layer; however, bursting additive 160 needs aligned with the environmental sensor 150, as discussed above in regard to FIG. 14B. Some non-limiting example methods to always have the bursting additive 160 aligned, would be to have the bursting additive 160 cover an entire layer as shown in FIG. 17B, have the bursting additive 160 be dispersed with the microcapsules 154 in the carrier material 152 as shown in FIG. 13B, or have the microcapsules 154 be disposed in a layer between the bursting additive 160 and the face sheet 130. Even though the environmental sensor 150 is attached to the top surface of the face sheet 130 layer, any area on the face sheet 130 layer can be printed with a thermal transfer printing process or a direct thermal printing process. For a direct thermal printing process to be performed a heat activated thermal coating would need added to the media element 850 (see FIGS. 26A-35B for some example media elements with heat activated thermal coating).

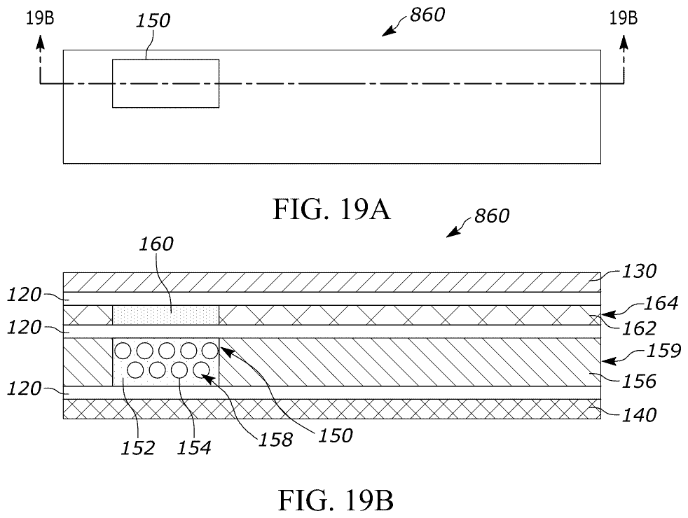

FIG. 19B illustrates a diagram of a cross-section of the media element 860 taken along the cross-section line shown in FIG. 19A, according to at least one aspect of the present disclosure. Media element 860 is substantially similar to media elements 810, 820, 830, 840, and 850, and for the sake of brevity not all the similarities will be discussed in detail. FIG. 19B illustrates that the bursting additive 160 can be added to a bursting additive layer 164 above the environmental sensor layer 159 (e.g. a layer between the face sheet 130 and the environmental sensor layer 159). The media elements 810, 820, 830, 840, and 850 show the bursting additive 160 added to a layer below the environmental sensor layer 159 (e.g. a layer between the environmental sensor layer 159 and the release liner 140). However, any of the media elements 810, 820, 830, 840, and 850 can be adjusted to have the bursting additive 160 added to a layer above the environmental sensor layer 159 as shown in FIG. 19B. The bursting additive 160 being above or below the environmental sensor 150 does not change how the bursting additive 160 functions, which is discussed in regard to FIG. 14B. For example, a force applied to the top and bottom of the media element 860 would cause the bursting additive 160 to interact with the microcapsules 154.

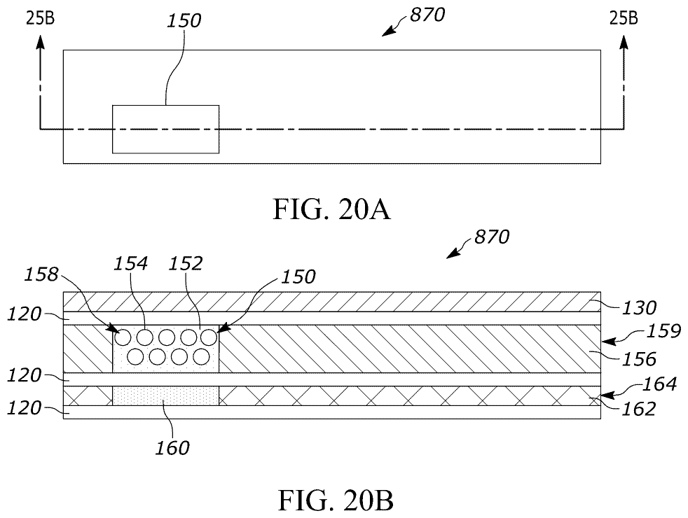

FIG. 20B illustrates a diagram of a cross-section of the media element 870 taken along the cross-section line shown in FIG. 20A, according to at least one aspect of the present disclosure. Media element 870 is substantially similar to media elements 810, 820, 830, 840, 850, and 860, and for the sake of brevity not all the similarities will be discussed in detail. FIG. 20B illustrates that the printable substrate that includes the environmental sensor 150 and the bursting additive 160 does not need to be attached to a release liner 140. For example, the media element 870 is liner-less and does not include a release liner 140.

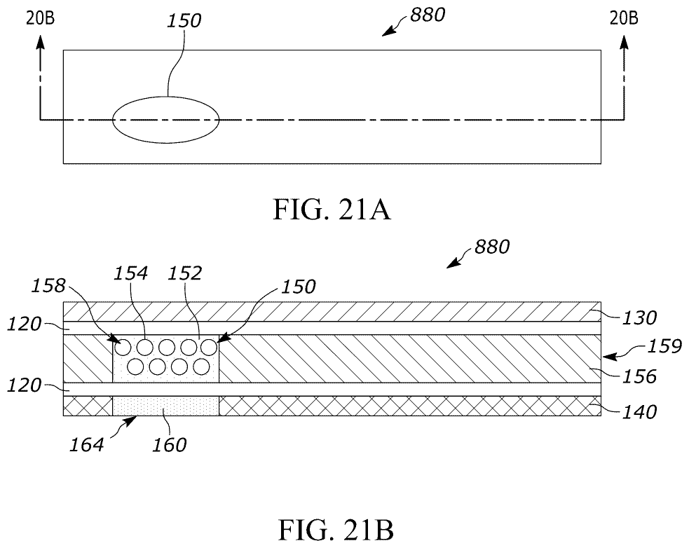

FIG. 21B illustrates a diagram of a cross-section of the media element 880 taken along the cross-section line shown in FIG. 21A, according to at least one aspect of the present disclosure. Media element 880 is substantially similar to media elements 810, 820, 830, 840, 850, 860, and 870, and for the sake of brevity not all the similarities will be discussed in detail. FIG. 21B illustrates that the bursting additive 160 can be added to the release liner 140. In at least one aspect, the bursting additive 160 is added to a layer within the release liner 140, as shown in FIG. 21B. In an alternative aspect, the bursting additive 160 can be added to the top or bottom of the release liner 140. The bursting additive 160 is aligned with the environmental sensor 150 as discussed in regard to FIG. 14B. The bursting additive 160 being in or on the release liner 140 does not change how the bursting additive 160 functions, which is discussed in regard to FIG. 14B. For example, a force applied to the top and bottom of the media element 870 would cause the bursting additive 160 to interact with the microcapsules 154. The release liner 140 is removed to place the printable substrate on an object. The removal of the release liner 140 would also remove the bursting additive 160 inside of the release liner 140.

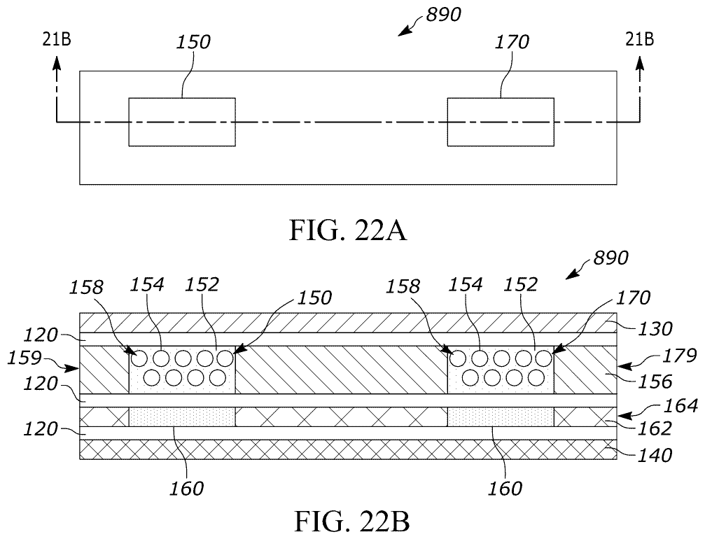

FIG. 22A shows a media element 890 with two environmental sensors 150 and 170 covering two different areas of the media element 890. When the two environmental sensors 150 and 170 are in the activated configuration, then the indicator material 158 is configured to respond to the same type of predetermined environmental condition (e.g. humidity, temperature, oxygen level, etc.). For example, the environmental sensors 150 and 170 could respond to a predetermined environmental condition of a temperature above a threshold. In at least one aspect, the environmental sensors 150 and 170 could respond to the same temperature threshold. In an alternative aspect, the environmental sensor 150 could respond to first temperature threshold and environmental sensor 170 could respond to a second temperature threshold, where the second temperature threshold is greater (i.e. higher temperature) than the first temperature threshold.

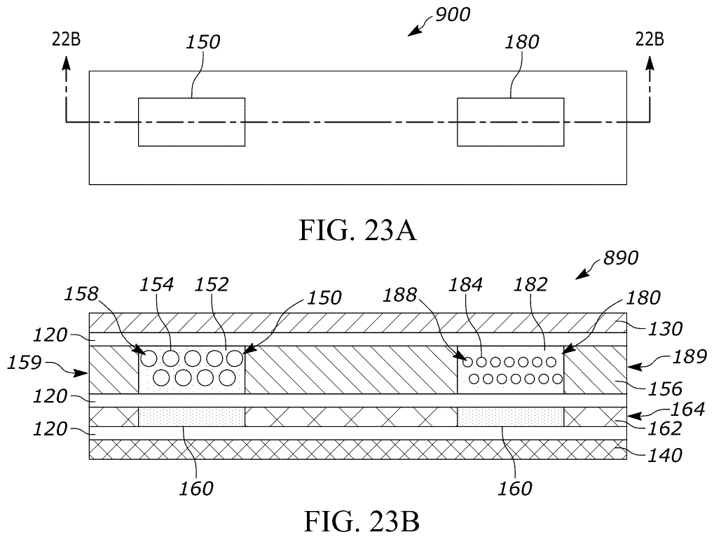

FIGS. 23A, 24A, and 25A show two environmental sensors 150 and 180 covering two different areas of the media elements 900, 910, and 920, respectively. In the activated configuration, the indicator material 158 in the environmental sensor 150 is configured to respond to a first predetermined environmental condition. In the activated configuration, the indicator material 188 in the environmental sensor 180 is configured to respond to a second predetermined environmental condition. In at least one aspect, the first predetermined environmental condition is different than the second predetermined environmental condition (e.g. the first predetermined environmental condition could be temperature and the second predetermined environmental condition could be humidity). For example, the environmental sensors 150 and 180 are different types of environmental sensors that are on the same media element 100. Some examples of predetermined environmental conditions and corresponding indicator materials 158 and 188 are discussed in regard to FIGS. 8-12.

The environmental sensors 150, 170, and 180 can be positioned in different locations, sizes, and shapes on a media element. The media elements 890, 900, 910, and 920 can be printed with a thermal transfer printing process or direct thermal printing process in any area of the media element including the area covered by the environmental sensor 150 as discussed in regard to FIGS. 13A and 13B. For a direct thermal printing process to be performed a heat activated thermal coating would is added to the media element 890, 900, 910, and 920 (see FIGS. 26A-35B for some example media elements with heat activated thermal coating).

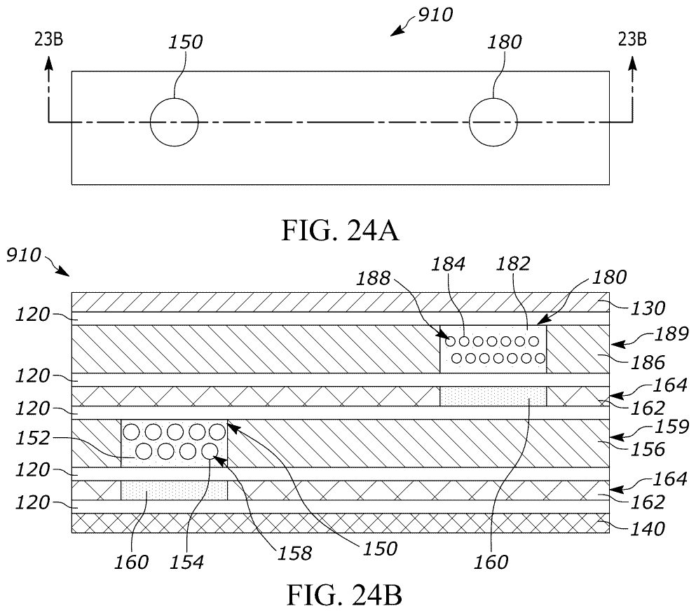

FIG. 22B illustrates a cross-section of the media element 890 taken along the cross-section line shown in FIG. 22A, according to at least one aspect of the present disclosure. Media element 890 is substantially similar to media elements 810, 820, 830, 840, 850, 860, 870, and 880, and for the sake of brevity not all the similarities will be discussed in detail. FIG. 22B illustrates that a media element 890 can have more than one environmental sensor covering two different areas of the media element 890. The media element 890 shows two environmental sensors 150 and 170; however, any number of environmental sensors can be added to the media element 890. The environmental sensors 150 and 170 are the same type of environmental sensor and have the same indicator material 158 contained within the microcapsules 154. The environmental sensors 150 and 170 are positioned in the same layer of the printable substrate. In an alternative aspect, the environmental sensors 150 and 170 can be positioned in different layers (see FIG. 24B). The bursting additives 160 for the sensors 150 and 170 are positioned in the same layer 164 of the printable substrate separate from the sensor layer(s) 159 and 179 (in FIG. 22B sensor layer 159 and sensor layer 179 are the same layer) including the sensors 150 and 170. In an alternative aspect, the bursting additives 160 can be positioned in different layers 164 and 166 (see FIG. 24B), which can be separate from the layer(s) 159 and 179 including the sensors 150 and 170. In alternative aspect, the bursting additive 160 can be dispersed and co-located with the microcapsules 154 of the sensors 150 and 170 as shown in FIG. 13B.

FIG. 22B shows the bursting additives 160 aligned with the environmental sensors 150 and 170. As shown in FIG. 22B, the environmental sensors 150 and 170 are shown as the same type of environmental sensor. However, the bursting additives 160 can be different. In at least one aspect, the bursting additive 160 aligned with the environmental sensor 150 can comprise a first material or type of abrasive surface and the bursting additive 160 aligned with the environmental sensor 170 can comprise a second material or different type of abrasive surface. In some aspects, the bursting additive 160 can be included for one of the sensors 150 and 170, but not the other such that the bursting additive 160 can interact, for example, with the sensor 150, but not the sensor 170 or vice versa.

FIG. 23B illustrates a cross-section of the media element 900 taken along the cross-section line shown in FIG. 23A, according to at least one aspect of the present disclosure. Media element 900 is substantially similar to media elements 810, 820, 830, 840, 850, 860, 870, 880, and 890, and for the sake of brevity not all the similarities will be discussed in detail. FIG. 23B illustrates that a media element 900 can have more than one type of environmental sensor covering two different areas of the media element 900. The media element 900 shows two environmental sensors 150 and 180; however, any number of environmental sensors can be added to the media element 900. The environmental sensors 150 and 180 are the different types of environmental sensors and have different indicator materials 158 contained within the microcapsules 154, 184, respectively. The environmental sensor 150 can include a carrier material 152 and the environmental sensor 180 can include a carrier material 182. In at least one aspect, the carrier material 182 is the same as the carrier material 152. In an alternative aspect, the carrier material 182 is different from the carrier material 152 but performs the same function as carrier material 152.

The environmental sensors 150 and 180 are positioned in the same sensor layer of the printable substrate. FIG. 23B shows the sensor layer 159 and the sensor layer 189 being the same layer. In an alternative aspect, the environmental sensors 150 and 180 can be positioned in different sensor layers 159 and 189 (see FIG. 24B). The bursting additives 160 are positioned in the same layer of the printable substrate separate from the layer(s) 159 and 189 including the sensors 150 and 180, respectively. In an alternative aspect, the bursting additives 160 can be positioned in different layers (see FIG. 24B) separate from the layer(s) 159 and 189 including the sensors 150 and 180, respectively. In alternative aspect, the bursting additive 160 can be dispersed and co-located with the microcapsules 154 of the sensors 150 and 180 as shown in FIG. 13B. Similar to media element 890, the bursting additives 160 can be different based on which environmental sensor 150 or 180 the bursting additive 160 is aligned. In some aspects, the bursting additive 160 can be included for one of the sensors 150 and 180, but not the other such that the bursting additive 160 can interact, for example, with the sensor 150, but not the sensor 180 or vice versa.

FIG. 24B illustrates a cross-section of the media element 910 taken along the cross-section line shown in FIG. 24A, according to at least one aspect of the present disclosure. Media element 910 is substantially similar to media elements 810, 820, 830, 840, 850, 860, 870, 880, 890, and 900, and for the sake of brevity not all the similarities will be discussed in detail. FIG. 24B illustrates that environmental sensors 150 and 180 and their aligned bursting additives 160 can each be positioned on their own layer in the printable substrate of the media element 910. For example, the environmental sensor 150 can be positioned in layer 159, the environmental sensor 180 can be positioned in layer 189, and the bursting additives 160 can be positioned in layers 164 and 166. The bursting additives 160 can be different based on which environmental sensor 150 or 180 the bursting additive 160 is aligned, as discussed in regard to FIGS. 23B and 24B. There can be any number of layers between the environmental sensor 150 or 180 and their aligned bursting additive 160.

The layer 189 with the environmental sensor 180 has a fill material 186. Similar to fill material 156, the fill material 186 can be part of the environmental sensor (e.g. a wicking material to move the indicator material 158 along the substrate) or the fill material can be used to just bridge the gap between the layers form by the thickness of the microcapsules 184 (e.g. a face sheet 130 material). In some aspects, the fill material 156 and 186 are the same material. In some alternative aspects, the fill material 156 is different than the fill material 186. In some aspects, the top sheet 130, the fill material 186, the fill material 162 are transparent to allow the environmental sensor 150 to be seen through the top sheet 130 and the layers 189 and 164.

FIG. 25B illustrates a cross-section of the media element 920 taken along the cross-section line shown in FIG. 25A, according to at least one aspect of the present disclosure. Media element 920 is substantially similar to media elements 810, 820, 830, 840, 850, 860, 870, 880, 890, 900, and 910, and for the sake of brevity not all the similarities will be discussed in detail. FIG. 25B illustrates that environmental sensors 150 and 180 are positioned in their own layers 159 and 189 of the printable substrate. Both of the bursting additives 160 are positioned in the same layer 164 of the printable substrate and are aligned with their respective environmental sensors 150 or 180. The bursting additives 160 can be different based on which environmental sensor 150 or 180 the bursting additive 160 is aligned, as discussed in regard to FIGS. 23B, 24B, and 25B. There can be any number of layers between the environmental sensor 150 or 180 and their aligned bursting additive 160.

The media elements 800, 810, 820, 830, 840, 850, 860, 870, 880, 890, 900, 910, and 920 are some examples of possible media elements. The reader will readily appreciate that different components of the media elements 800, 810, 820, 830, 840, 850, 860, 870, 880, 890, 900, 910, and 920 can be combined together to form a new media element. For example, a media element can have two environmental sensors (see FIGS. 22A-25B) where the environmental sensors include both microcapsules and a bursting additive 160 (see FIG. 13B). Another example, is that a media element can have two environmental sensors (see FIGS. 22A-25B) and a single bursting additive 160 that covers the area of both environmental sensors (see FIG. 17B). And yet another example, is that a media element can be liner-less (see FIG. 20B), the environmental sensor can include both microcapsules and a bursting additive 160 (see FIG. 13B), and the environmental sensor can be placed without a carrier material (see FIG. 14B). There are many more examples that are not discussed for the sake of brevity.

The media elements 800, 810, 820, 830, 840, 850, 860, 870, 880, 890, 900, 910, and 920 are configured for a thermal transfer printing process. To perform a direct thermal printing process a heat activated thermal coating would need added to the media elements 810, 820, 830, 840, 850, 860, 870, 880, 890, 900, 910, and 920. FIGS. 26A-35B show some example media elements 930, 940, 950, 960, 970, 980, 990, 1000, 1010, and 1020 with a heat activated thermal coating 190. A heat activated thermal coating 190 can be added to a layer of the media elements 800, 810, 820, 830, 840, 850, 860, 870, 880, 890, 900, 910, and 920 similar to any of the media elements 930, 940, 950, 960, 970, 980, 990, 1000, 1010, and 1020.

FIGS. 26A, 27A, 28A, 29A, 30A, 31A, 32A, 33A, 34A, and 35A show media elements 930, 940, 950, 960, 970, 980, 990, 1000, 1010, and 1020, respectively, that have an environmental sensor 150, a bursting additive 160, and a heat activated thermal coating 190. The environmental sensor 150 can be positioned, sized, and shaped, in any manner desired by the user. The media elements 930, 940, 950, 960, 970, 980, 990, 1000, 1010, and 1020 are configured to be printed with a direct thermal printing process in any area of the media element, and in some aspects, including the area covered by the environmental sensor 150.

FIG. 26B illustrates a cross-section of the media element 930 taken along the cross-section line shown in FIG. 26A, according to at least one aspect of the present disclosure. Media element 930 is substantially similar to media elements 810, 820, 830, 840, 850, 860, 870, 880, 890, 900, 910, and 920, and for the sake of brevity not all the similarities will be discussed in detail. FIG. 26B illustrates that a heat activated thermal coating 190 can be applied to a bottom of the top sheet 130. The environmental sensor 150 includes microcapsules 154 and a bursting additive 160, as discussed in regard to FIG. 13B).

During a direct thermal printing process, heat is applied to a portion of the heat activated thermal coating 190 causing that portion to darken and turn black. This process repeats to print the desired image onto the media element. In at least one aspect, the image being printed to the media element 930 can be configured so that no heat is applied to the area where the environmental sensor 150 is located. This would allow an observable effect of the environmental sensor to not be hidden by the black color of the activated heat activated thermal coating 190. For example, ink and/or text can appear in areas without the environmental sensor 150.

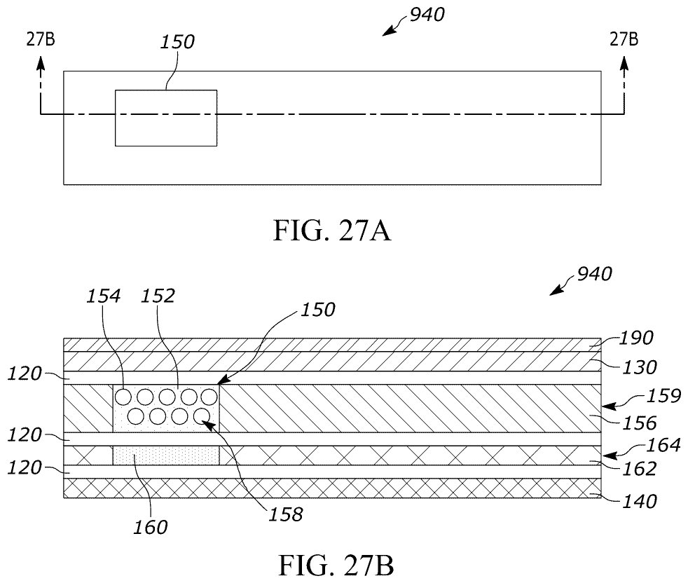

FIG. 27B illustrates a cross-section of the media element 940 taken along the cross-section line shown in FIG. 27A, according to at least one aspect of the present disclosure. Media element 940 is substantially similar to media elements 810, 820, 830, 840, 850, 860, 870, 880, 890, 900, 910, 920, and 930, and for the sake of brevity not all the similarities will be discussed in detail. FIG. 27B illustrates another example that a heat activated thermal coating 190 can be applied to a top surface of the top sheet 130. In at least one aspect, the heat activated thermal coating 190 is applied to a layer that is attached directly to the top sheet layer 130. The environmental sensor 150 is positioned in the sensor layer 159 of the printable substrate and the bursting additive 160 is positioned in a bursting additive layer 164 of the printable substrate, as discussed in regard to FIG. 14B. Direct thermal printing can be performed similar to the process described in regard to FIG. 26B to avoid printing black over the environmental sensor 150 unless the user desires to print black over an area of the environmental sensor 150.

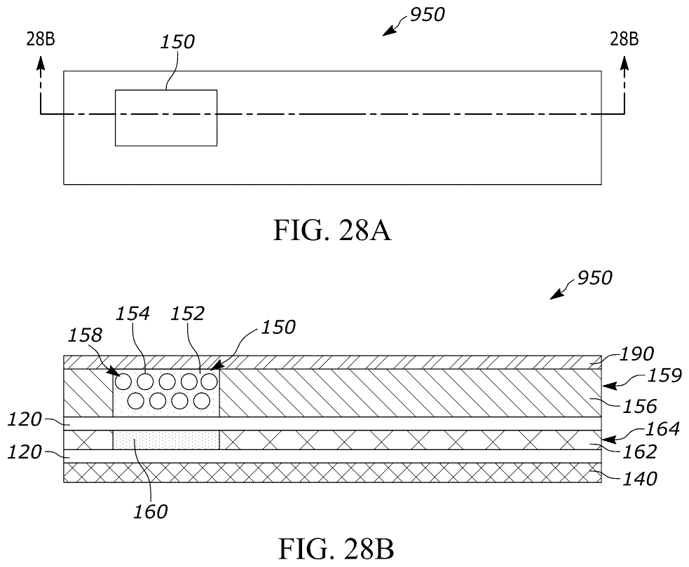

FIG. 28B illustrates a cross-section of the media element 950 taken along the cross-section line shown in FIG. 28A, according to at least one aspect of the present disclosure. Media element 950 is substantially similar to media elements 810, 820, 830, 840, 850, 860, 870, 880, 890, 900, 910, 920, 930, and 940, and for the sake of brevity not all the similarities will be discussed in detail. FIG. 28B illustrates that a heat activated thermal coating 190 can be applied to a top surface of the sensor layer 159. In at least one aspect, the fill material 156 is face sheet 130 material. Direct thermal printing can be performed similar to the process described in regard to FIG. 26B to avoid printing black over the environmental sensor 150 unless the user desires to print black over an area of the environmental sensor 150.

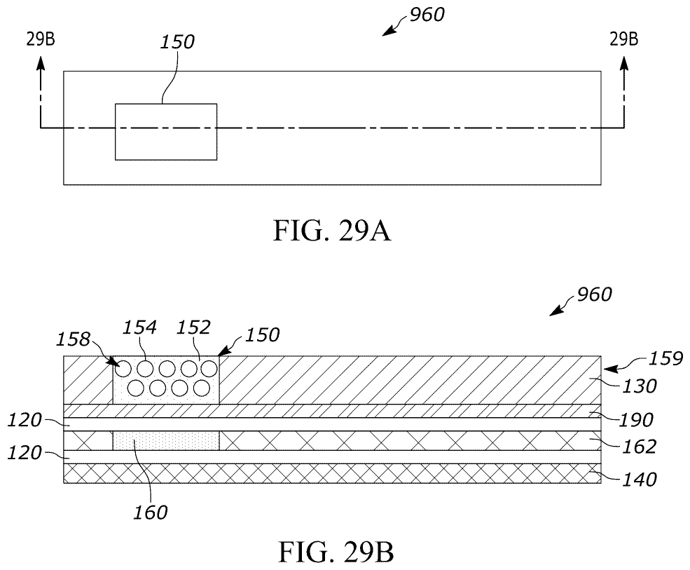

FIG. 29B illustrates a cross-section of the media element 960 taken along the cross-section line shown in FIG. 29A, according to at least one aspect of the present disclosure. Media element 960 is substantially similar to media elements 810, 820, 830, 840, 850, 860, 870, 880, 890, 900, 910, 920, 930, 940, and 950, and for the sake of brevity not all the similarities will be discussed in detail. FIG. 29B illustrates that a heat activated thermal coating 190 can be applied to a bottom surface of the sensor layer 159. In an alternative aspect, the heat activated thermal coating 190 can be applied to a top surface of the bursting additive layer 164 instead of the bottom surface of the sensor layer 159. The environmental sensor 150 is shown positioned within the sensor layer 159 and surrounded by face sheet 130 similar to media element 820 (FIG. 15B). Direct thermal printing can be performed similar to the process described in regard to FIG. 26B to avoid printing black over the environmental sensor 150 unless the user desires to print black over an area of the environmental sensor 150.

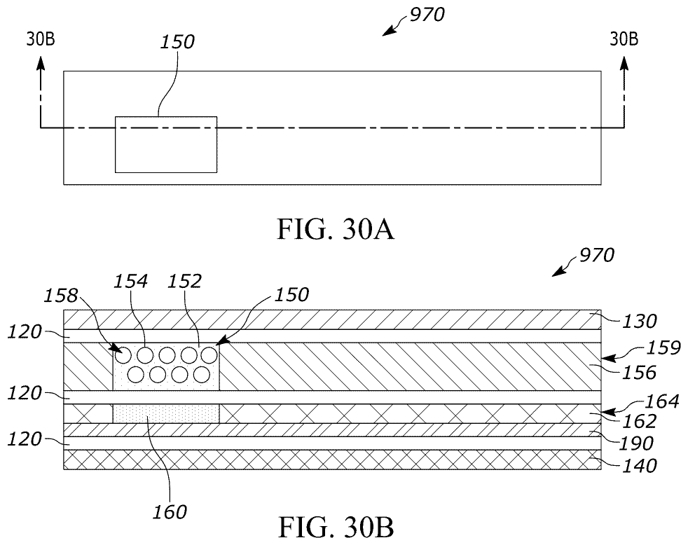

FIG. 30B illustrates a cross-section of the media element 970 taken along the cross-section line shown in FIG. 30A, according to at least one aspect of the present disclosure. Media element 970 is substantially similar to media elements 810, 820, 830, 840, 850, 860, 870, 880, 890, 900, 910, 920, 930, 940, 950, and 960, and for the sake of brevity not all the similarities will be discussed in detail. FIG. 30B illustrates that a heat activated thermal coating 190 can be applied to a bottom surface of the bursting additive layer 164. The bursting additive layer 164 includes the bursting additive 160 and the fill material 162. For example, the heat activated thermal coating 190 can be applied to a layer between the bursting additive layer 164 and the release liner 140. In at least one aspect, the heat activated thermal coating 190 can be applied to a layer that attaches directly to the release liner 140. Direct thermal printing can be performed similar to the process described in regard to FIG. 26B to avoid printing black over the environmental sensor 150 unless the user desires to print black over an area of the environmental sensor 150.

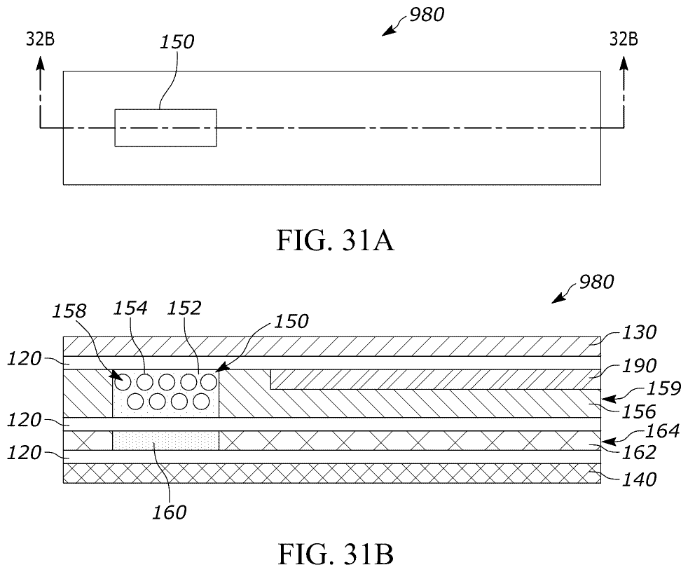

FIG. 31B illustrates a cross-section of the media element 980 taken along the cross-section line shown in FIG. 31A, according to at least one aspect of the present disclosure. Media element 980 is substantially similar to media elements 810, 820, 830, 840, 850, 860, 870, 880, 890, 900, 910, 920, 930, 940, 950, 960, and 970, and for the sake of brevity not all the similarities will be discussed in detail. FIG. 31B illustrates that a heat activated thermal coating 190 can be applied to a layer positioned within the fill material 156. The sensor layer 159 with the environmental sensor 150 has fill material 156 positioned to at least bridge the gap between the layers formed by the thickness of the environmental sensor 150. In some aspects, the fill material 156 can be part of the environmental sensor 150 (e.g. some of the fill material 156 can be a wicking material). In an additional/alternative aspect, the fill material 156 is mainly used to just bridge the gap between layers formed by the thickness of the microcapsules 154 (e.g. the fill material can be face sheet 130 material). FIG. 31B shows that the sensor layer 159 can have a heat activated thermal coating 190 within the fill material 156. In at least one aspect, the heat activated thermal coating 190 is positioned to cover an area covering everywhere other than the area covered by the environmental sensor 150. In an alternative aspect, the heat activated thermal coating 190 is positioned to cover an area to be printed that does not include the area covered by the environmental sensor 150.

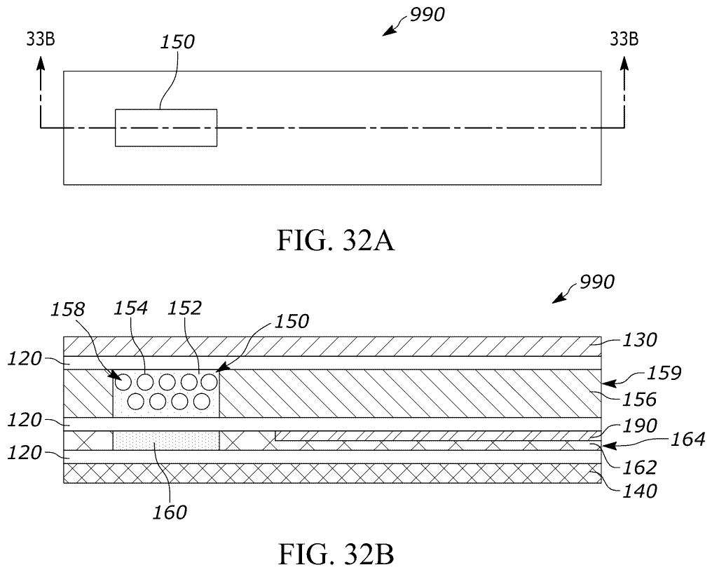

FIG. 32B illustrates a cross-section of the media element 990 taken along the cross-section line shown in FIG. 312A, according to at least one aspect of the present disclosure. Media element 980 is substantially similar to media elements 810, 820, 830, 840, 850, 860, 870, 880, 890, 900, 910, 920, 930, 940, 950, 960, 970, and 980, and for the sake of brevity not all the similarities will be discussed in detail. FIG. 32B illustrates that a heat activated thermal coating 190 can be applied to the bursting additive layer 164 and be positioned within the fill material 162. The bursting additive layer 164 has fill material 162 positioned to at least bridge the gap between the layers formed by the thickness of the bursting additive 160. FIG. 32B shows that the bursting additive layer 164 can have a heat activated thermal coating 190 within the fill material 162. In at least one aspect, the heat activated thermal coating 190 is positioned to cover an area covering everywhere other than the area covered by the environmental sensor 150. In an alternative aspect, the heat activated thermal coating 190 is positioned to cover an area to be printed that does not include the area covered by the environmental sensor 150.

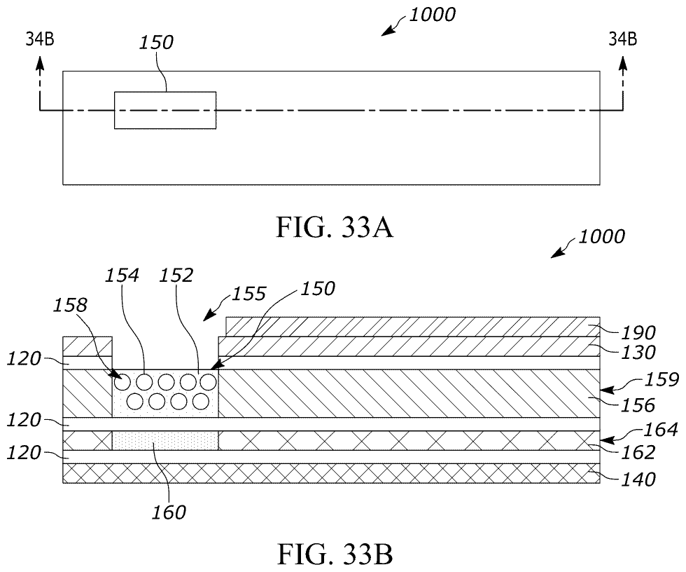

FIG. 33B illustrates a cross-section of the media element 1000 taken along the cross-section line shown in FIG. 33A, according to at least one aspect of the present disclosure. Media element 980 is substantially similar to media elements 810, 820, 830, 840, 850, 860, 870, 880, 890, 900, 910, 920, 930, 940, 950, 960, 970, 980, and 990, and for the sake of brevity not all the similarities will be discussed in detail. FIG. 33B illustrates that a heat activated thermal coating 190 can be applied to the top surface of the top sheet 130, where the heat activated thermal coating 190 does not cover the area covered by the environmental sensor 150. In at least one aspect, the heat activated thermal coating 190 is positioned to cover an area covering everywhere other than the area covered by the environmental sensor 150. The layer with the heat activated thermal coating 190 can be positioned at any layer in the printable substrate (e.g. above the environmental sensor layer 159, below the busting additive layer 164, or between the environmental sensor layer 159 and the bursting additive layer 164). In at least one aspect, the layer with the heat activated thermal coating 190 includes face sheet (or some other fill material) at any areas not covered by the heat activated thermal coating 190.

Media element 1000 includes a window 155 that allows an observable effect to be seen through the top sheet 130. Similar to FIGS. 14B and 17B, the window 155 can allow the indicator material 158 access to the environment (e.g. for a humidity environmental sensor where the indicator material 158 needs exposed to the air humidity). As discussed in regard to FIG. 14B, the top sheet 130 can be opaque, transparent, or partially opaque/transparent.

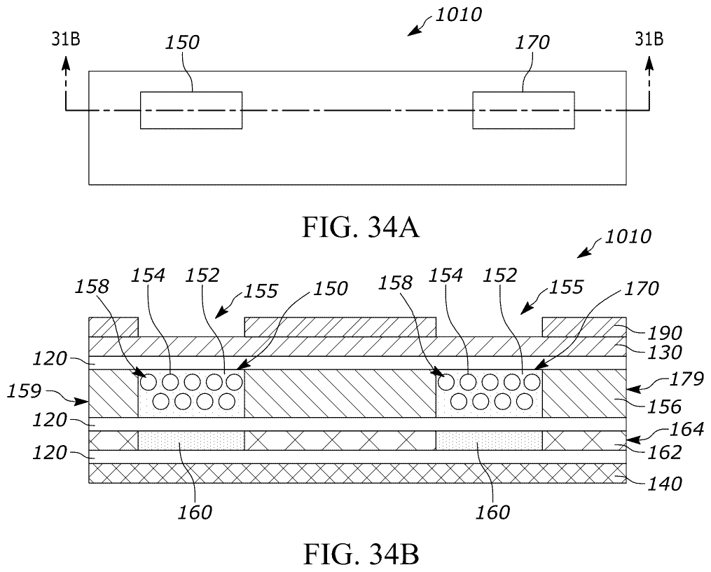

FIG. 34B illustrates a cross-section of the media element 1010 taken along the cross-section line shown in FIG. 34A, according to at least one aspect of the present disclosure. Media element 980 is substantially similar to media elements 810, 820, 830, 840, 850, 860, 870, 880, 890, 900, 910, 920, 930, 940, 950, 960, 970, 980, 990, and 1000, and for the sake of brevity not all the similarities will be discussed in detail. FIG. 34B illustrates that a heat activated thermal coating 190 can be applied to the top surface of the top sheet 130, where the heat activated thermal coating 190 does not cover the area covered by the environmental sensors 150 or 170. In at least one aspect, the top sheet 130 is transparent and the heat activated thermal coating 190 can be slightly opaque before activation of the coating, which forms windows 155 around the environmental sensors 150 and 170. In an alternative aspect, the heat activated thermal coating 190 is transparent before activation and the windows 155 are formed by activating the heat activated thermal coating 190 around the environmental sensors 150 and 170.

While the media element 1010 shows two environmental sensors, any number of environmental sensors can be added to the media element 1010. In at least one aspect, the heat activated thermal coating 190 is positioned to cover an area covering everywhere other than the areas covered by the environmental sensors 150 and 170. In an alternative aspect, the heat activated thermal coating 190 is positioned to cover an area to be printed that does not include the areas covered by the environmental sensors 150 and 170. The layer with the heat activated thermal coating 190 can be positioned at any layer in the printable substrate (e.g. above the environmental sensor layer 159, below the busting additive layer 164, or between the environmental sensor layer 159 and the bursting additive layer 164). In at least one aspect, the layer with the heat activated thermal coating 190 includes face sheet (or some other fill material) at any areas not covered by the heat activated thermal coating 190.

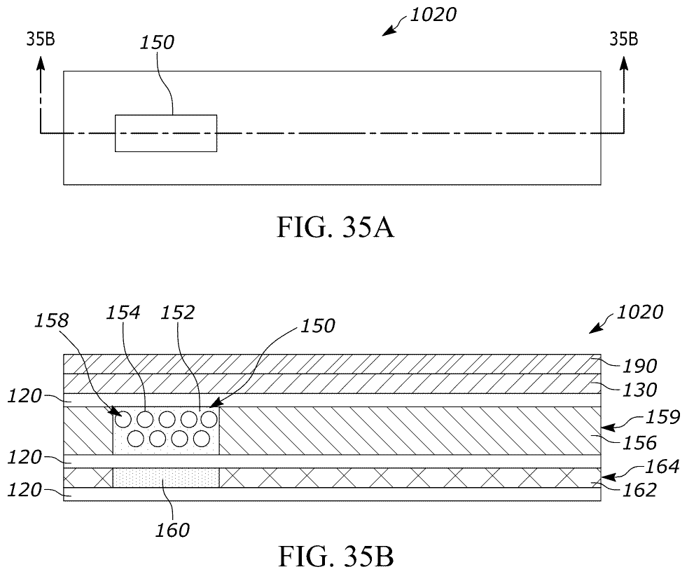

FIG. 35B illustrates a cross-section of the media element 1020 taken along the cross-section line shown in FIG. 35A, according to at least one aspect of the present disclosure. Media element 930 is substantially similar to media elements 810, 820, 830, 840, 850, 860, 870, 880, 890, 900, 910, 920, 930, 940, 950, 960, 970, 980, 990, 1000, and 1010, and for the sake of brevity not all the similarities will be discussed in detail. FIG. 35B illustrates that a heat activated thermal coating 190 can be applied to a top surface of the top sheet 130. The media element 1020 is liner-less. For example, the media element 1020 does not include a release liner 140. Direct thermal printing can be performed similar to the process described in regard to FIG. 26B to avoid printing black over the environmental sensor 150 unless the user desires to print black over an area of the environmental sensor 150.

The media elements 810, 820, 830, 840, 850, 860, 870, 880, 890, 900, 910, 920, 930, 940, 950, 960, 970, 980, 990, 1000, 1010, and 1020 are some examples of possible media elements. The reader will readily appreciate that different components of the media elements 810, 820, 830, 840, 850, 860, 870, 880, 890, 900, 910, 920, 930, 940, 950, 960, 970, 980, 990, 1000, 1010, and 1020 can be combined together to form a new media element. For example, a media element can have two environmental sensors (see FIGS. 22A-25B), the environmental sensors can include both microcapsules and a bursting additive 160 (see FIG. 13B), the media element can include a window 155 (see FIG. 33B), and the environmental sensor can include a heat activated thermal coating positioned in the fill material of the environmental sensor (see FIG. 31B). Another example, is that a media element can have two environmental sensors (see FIGS. 22A-25B), a single bursting additive 160 that covers the area of both environmental sensors (see FIG. 17B), a window 155 formed over the area covered by the environmental sensor, and a heat activated thermal coating positioned within the printable substrate and covering the an area on the media element that is not covered by the environmental sensors (see FIG. 33B). And yet another example, is that a media element can be liner-less (see FIG. 20B), the environmental sensor 150 can include both microcapsules and a bursting additive 160 (see FIG. 13B), the environmental sensor 150 can be placed without a carrier material (see FIG. 14B), and the printable substrate can include a heat activated thermal coating applied to an entire layer (see FIG. 27B). There are many more examples that are not discussed for the sake of brevity.

FIG. 36 illustrates a diagram of an example media element passing between two activation mechanism components 110, 112, where the media element includes a bursting additive 160, according to at least one aspect of the present disclosure. The media element can be any one of media elements 810, 820, 830, 840, 850, 860, 870, 880, 890, 900, 910, 920, 930, 940, 950, 960, 970, 980, 990, 1000, 1010, or 1020, or any combinations of these media elements.

In at least one aspect, the activation mechanism components 110, 112 cause at least a portion of the microcapsules 154 to rupture as the media element is between activation mechanism components 110, 112. As the activation mechanism components 110, 112 apply a force greater than the predetermined threshold to the media element, the bursting additive 160 selectively interacts with the microcapsules 154 causing at least a portion of the microcapsules 154 to rupture. The bursting additive 160 increases the effective force applied to the individual microcapsules 154 which increases the strain on the individual microcapsules 154. This process can reduce the amount of force needed to be applied by the activation mechanism components to rupture the microcapsules 154, which in turn can reduce the predetermined threshold making it easier for the activation mechanism to rupture a portion of the microcapsules 154 and placed the environmental sensor 150 in the activated configuration.

The releasing of the environmental indicator material 158 from microcapsules 154 transitions the environmental sensor on the media element from a non-activated configuration to an activated configuration. Once in the activated configuration, the environmental sensor can change from an initial sensor state to a second sensor state upon exposure of the environmental indicator material 158 to the predetermined environmental condition. After the environmental indicator material 158 is exposed to the predetermined environmental condition, then the environmental indicator material 158 changes from an initial material state to a second material state producing an observable effect.

The activation mechanism components 110, 112 can be part of a media processing device, e.g. media processing device 300. In at least one aspect, the activation mechanism components 110, 112 can correspond to the print head 460 and platen roller 480 of the media processing device 300. For example, as a media element, e.g. media element 100, with an environmental sensor passes between the platen roller 480 and print head 460, the media processing device 300 applies a force on the media element through the platen roller 480 and the print head 460. The force applied by the platen roller 480 and the print head 460 to the media element is greater than or equal to the predetermined threshold, which causes the bursting additive 160 to selectively interact with the microcapsules 154 such that a portion of the microcapsules 154 in the environmental sensor are ruptured. In at least one aspect, the force is a pressure force and the predetermined threshold can be between 1.5 pounds per square inch and 8 pounds per square inch. For example, the predetermined threshold can be 5 pounds per square inch and the platen roller 480 and the print head 460 can supply a force of 8 pounds per square inch to the media element causing a portion of the microcapsules 154 to rupture.

In at least one aspect, the media element can be printed with a thermal transfer printing process and the force applied by the platen roller 480 and the print head 460 to the media element during the thermal transfer printing process can rupture at least a portion of the microcapsules 154 in the environmental sensor on the media element. As such, the environmental sensor on the media element can transition from the non-activated configuration to the activated configuration during the thermal transfer printing process.

In at least one aspect, the media element includes a heat activated thermal coating. In this aspect, the media element can be printed with a direct thermal printing process and the force applied by the platen roller 480 and the print head 460 to the media element during the direct thermal printing process can rupture at least a portion of the microcapsules 154 in the environmental sensor on the media element. As such, the environmental sensor on the media element can transition from the non-activated configuration to the activated configuration during the direct thermal printing process.

In at least one aspect, the portion of the microcapsules 154 are ruptured based on both a force applied to the microcapsules 154 and a temperature of the microcapsules 154, where the force exceeds or equals a predetermined threshold and the temperature of the microcapsules 154 exceeds or is equal to a predetermined temperature threshold. In this aspect, the print head 460 is configured to apply the heat required to raise the temperature of the microcapsules 154 above the predetermined temperature threshold and the print head 460 and platen roller 480 can apply a force to the microcapsules 154 as a media element passed between the print head 460 and platen roller 480.

In an alternative aspect, the activation mechanism components 110, 112 are part of an activation mechanism located upstream or downstream of the printing assembly 400 in the media processing device 300.

In an alternative aspect, the activation mechanism components 110, 112 are part of a user's hand. For example, a media processing device 300 can perform a printing process (e.g. a thermal transfer printing process or a direct thermal printing process) on the media element and the media element can exit the media processing device 300 with the environmental sensor 150 in the non-activated configuration. A user can then place the environmental sensor in the activated configuration by hand when the user desires. In this aspect, the activation mechanism components 110, 112 are part of the user's hand (e.g. fingers). The predetermined threshold can be at least 20 pounds per square inch and the user can have to grasp or pinch the environmental sensor such that the pressure force applied to the environmental sensor 150 is greater than the predetermined threshold. For example, an average person can exert a grip strength between 20 to 50 pounds per square inch. In some aspects, the user can use a hand held device to apply the pressure to the media element.

One method of activating an activatable media element, e.g. media elements 810, 820, 830, 840, 850, 860, 870, 880, 890, 900, 910, 920, 930, 940, 950, 960, 970, 980, 990, 1000, 1010, or 1020, or any combinations of these media elements, includes feeding the activatable media element into an upstream end of a printing mechanism, e.g. printing mechanism 400. The method further includes printing the media element using the printing mechanism. The method further includes rupturing at least a portion of the microcapsules 154 by applying at least one of a pressure force, a shear force, a frictional force, or a cutting force equal to or greater than a predetermined threshold to the media element. The bursting additive 160 selectively interacts with the microcapsules 154 to rupture at least a portion of the microcapsules 154 when the force is applied to the microcapsules 154 and bursting additive 160. The rupturing of the portion of the microcapsules 154 placed the environmental sensor in the activated configuration. The method further includes ejecting the media element out of a downstream end of the printing mechanism and out of the media processing device.

In at least one aspect, the portion of the microcapsules 154 are ruptured during printing the media element using the printing mechanism. In this aspect, the print head and platen roller of the printing mechanism supply the force above the predetermined threshold. In at least one aspect, the predetermined threshold is between 1.5 and 8 pounds per square inch. In an alternative aspect, the force is between 4 and 15 pounds per square inch.

In an alternative aspect, the portion of the microcapsules 154 are not ruptured during printing the media element using the printing mechanism. In this aspect, the media element is ejected from the media processing device without the portion of the microcapsules 154 being ruptured. In at least one aspect, the method further includes storing the printed media element in the non-activated configuration. In this aspect, there is a delay between printing the media element and placing the environmental sensor in the activated configuration.

In at least one aspect, the method further includes feeding the media element back into the media processing device to rupture the portion of the microcapsules 154. In this aspect, the print head and platen roller of the printing mechanism supply the force above the predetermined threshold.

In an alternative aspect, the method further comprises applying, by a user, a pressure greater than the predetermined threshold outside of the media processing device. For example, a user can grasp the media element in their hand and use their grip strength to rupture the portion of the microcapsules 154. The user can also use a hand held device to apply the force to the media element. In at least one aspect, the predetermined threshold is at least 20 pounds per square inch.

In at least one aspect, the media element includes a printable substrate with the environmental sensor and a release liner attached to the printable substrate, where the release liner includes the bursting additive 160, as discussed in regard to FIG. 21B. The method further includes removing the release liner from the printable substrate to apply the printable substrate with the activated environmental sensor to an object. In this aspect, the bursting additive 160 is removed along with the release liner.

In the foregoing detailed description, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer readable medium, such as RAM, ROM, a magnetic medium such as a hard-drive or a floppy disk, or an optical medium such as a CD-ROM. Any such computer readable medium may reside on or within a single computational apparatus, and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

As used in any aspect herein, the term “control circuit” may refer to, for example, hardwired circuitry, programmable circuitry (e.g., a computer processor including one or more individual instruction processing cores, processing unit, processor, microcontroller, microcontroller unit, controller, digital signal processor (DSP), programmable logic device (PLD), programmable logic array (PLA), or field programmable gate array (FPGA)), state machine circuitry, firmware that stores instructions executed by programmable circuitry, and any combination thereof. The control circuit may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Accordingly, as used herein “control circuit” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

As used in any aspect herein, the terms “component,” “system,” “module” and the like can refer to a computer-related entity, either hardware, a combination of hardware and software, software, or software in execution.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions can be implemented by a state machine that has no stored program instructions, or in one or more application specific integrated circuits (ASICs), in which each function or some combinations of certain of the functions are implemented as custom logic. Of course, a combination of the two approaches can be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A media element for use with a media processing device, the media element comprising:
an environmental indicator material configured, in response to exposure to a predetermined environmental condition, to change from an initial state to a second state producing an observable effect;
a plurality of microcapsules, each microcapsule encapsulating the environmental indicator material in a non-activated configuration and releasing the environmental indicator material when ruptured, wherein the plurality of microcapsules prevent an occurrence of the observable effect while in the non-activated configuration, and allow the occurrence of the observable effect when the environmental indicator material is exposed to the predetermined environmental condition after at least a portion of the plurality of microcapsules are ruptured; and
a bursting additive proximate the plurality of microcapsules, wherein the bursting additive selectively interacts with the plurality of microcapsule to rupture the plurality of microcapsules when a force is applied to the plurality of microcapsules and bursting additive.

2. The media element of claim 1, wherein at least a portion of the plurality of microcapsules are ruptured based on a force greater than a predetermined threshold, the force being at least one of a pressure force, a shear force, a frictional force, or a cutting force applied to the media element.

3-9. (canceled)

10. The media element of claim 1, wherein the bursting additive increases an effective force applied to the microcapsules when the force is applied to the media element.

11. (canceled)

12. The media element of claim 1, further comprising a printable substrate comprising the plurality of microcapsules and the bursting additive.

13. (canceled)

14. The media element of claim 12, wherein the plurality of microcapsules are positioned in a first layer of the printable substrate and the bursting additive is positioned in a second layer of the printable substrate, wherein the plurality of microcapsules are aligned with the bursting additive.

15. (canceled)

16. The media element of claim 1, wherein the bursting additive comprises a plurality of microneedles.

17. The media element of claim 1, wherein the bursting additive comprises an abrasive material comprising a plurality of particles.

18-20. (canceled)

21. The media element of claim 1, wherein the bursting additive reduces an amount of force required to be applied to the media element to rupture the plurality of microcapsules.

22. The media element of claim 21, wherein at least a portion of the plurality of microcapsules are ruptured based on a pressure force being applied to the media element, and wherein the bursting additive reduces the amount of pressure force required to be applied to the media element in order to burst the microcapsules by anywhere between 5 to 90 percent.

23. (canceled)

24. The media element of claim 1, wherein the observable effect comprises at least one effect selected from the group consisting of a color state change, a change in transparency, a change in hue, a change in an electrical property, a change in conductivity, a change in capacitance, a movement of the environmental indicator material along a substrate, and combinations thereof.

25. The media element of claim 1, wherein the plurality of microcapsules prevent the observable effect by containing the environmental indicator material when it changes state.

26. The media element of claim 1, wherein the plurality of microcapsules prevent the observable effect by protecting the environmental indicator material from exposure to the predetermined environmental condition.

27. The media element of claim 1, wherein the predetermined environmental condition comprises at least one condition selected from the group consisting of temperature excursion above a predetermined temperature threshold for at least a predetermined amount of time, temperature excursion below a predetermined temperature for at least a predetermined amount of time, cumulative exposure to temperature over a time period above a predetermined threshold for at least a predetermined amount of time, exposure to a particular chemical, oxygen exposure, ammonia exposure, exposure to a particular chemical above a threshold concentration, exposure to a particular chemical above the threshold concentration for at least a predetermined amount of time, exposure to at least a predetermined amount of radiation of a particular type, ultraviolet light exposure, humidity exposure, exposure to a humidity level above a predetermined threshold, and exposure to a humidity level above a predetermined threshold for at least a predetermined amount of time.

28-37. (canceled)

38. A method of activating an activatable media element, the method comprising:
feeding the activatable media element into an upstream end of a print head assembly of a media processing device, wherein the activatable media element comprises:
an environmental indicator material configured, in response to exposure to a predetermined environmental condition, to change from an initial state to a second state producing an observable effect;
a plurality of microcapsules, each microcapsule encapsulating the environmental indicator material in an inactive configuration and releasing the environmental indicator material when ruptured, wherein the plurality of microcapsules prevent an occurrence of the observable effect while in the inactive configuration, and allow the occurrence of the observable effect when the environmental indicator material is exposed to the predetermined environmental condition after at least a portion of the plurality of microcapsules are ruptured; and
a bursting additive proximate the plurality of microcapsules;
rupturing at least a portion of the plurality of microcapsules by applying at least one of a pressure force, a shear force, a frictional force, or a cutting force equal to or greater than a predetermined threshold to the media element, wherein the bursting additive selectively interacts with the plurality of microcapsule to rupture the plurality of microcapsules when the force is applied to the plurality of microcapsules and bursting additive; and
ejecting the media element out of a downstream end of the print head assembly and out of the media processing device.

39. The method of claim 38, further comprising printing the activatable media element with the print head, wherein the at least the portion of the plurality of microcapsules are ruptured by the print head and roller while the activatable media element is printed, and wherein the print head and the roller apply the pressure force greater than the predetermined threshold to the activatable media element.

40-41. (canceled)

42. The method of claim 38, rupturing at least the portion of the plurality of microcapsules comprises applying, by a user, the pressure force greater than the predetermined threshold to the activatable media element outside of the media processing device.

43-47. (canceled)

48. The method of claim 38, wherein the bursting additive comprises particles, wherein the particles are harder than the plurality of microcapsules.

49-74. (canceled)

75. A method of forming an activatable media element, the method comprising:
adding a plurality of microcapsules to a layer of a printable media substrate of the activatable media element, each microcapsule encapsulating an environmental indicator material, the environmental indicator material is configured, in response to exposure to a predetermined environmental condition, to change from an initial state to a second state producing an observable effect, wherein the plurality of microcapsules are in a non-activated configuration and releasing the environmental indicator material when ruptured placing the plurality of microcapsules in an activated configuration, wherein the plurality of microcapsules prevent an occurrence of the observable effect while in the non-activated configuration, and allow the occurrence of the observable effect when the environmental indicator material is exposed to the predetermined environmental condition after at least a portion of the plurality of microcapsules are ruptured; and
adding a bursting additive proximate the plurality of microcapsules, where the bursting additive selectively interacts with the plurality of microcapsules to rupture the plurality of microcapsule when a force is applied to the activatable media element.

76. The method of claim 75, further comprising attaching a release liner to the media substrate of the media substrate of the activatable, wherein the bursting additive is positioned in the release liner.

77-78. (canceled)

79. The method of claim 75, wherein the layer of a printable media substrate is a first layer of the printable media substrate, wherein the bursting additive is positioned in a second layer of the printable substrate, and wherein the plurality of microcapsules are aligned with the bursting additive.

80-82. (canceled)
